(19) United States
(12) Patent Application Publication
(10) Pub. No.: US 2026/0148684 A1
(43) Pub. Date: May 28, 2026

(54) DISPLAY DEVICE

(71) Applicant: LG Display Co., Ltd., Seoul (KR)

(72) Inventors: NamYong GONG, Paju-si (KR); SungChul KIM, Paju-si (KR); HoonBae KIM, Paju-si (KR); SunYeop KIM, Paju-si (KR); Sung-Jin KANG, Paju-si (KR); Jongsung KIM, Paju-si (KR)

(73) Assignee: LG Display Co., Ltd., Seoul (KR)

(21) Appl. No.: 19/296,178

(22) Filed: Aug. 11, 2025

(30) Foreign Application Priority Data
Nov. 25, 2024 (KR) 10-2024-0169586

(51) Int. Cl. G09G 3/32; G06F 3/041; G06F 3/044

(52) U.S. Cl. CPC G09G 3/32; G06F 3/04186; G06F 3/0446; G09G 2300/0426; G09G 2310/08; G09G 2320/0233; G09G 2330/021; G09G 2380/02

(57) ABSTRACT

Embodiments of the present disclosure relate to a display device, and more particularly, relate to a new foldable display device including a substrate, a plurality of drivers, a plurality of light emitting devices, a plurality of column lines, and a plurality of row lines. The substrate may include a first display area, a second display area, a third display area, and a first bending area between the first display area and the second display area.

### CROSS REFERENCE TO RELATED APPLICATION

This application claims the benefit of and priority to Korean Patent Application No. 10-2024-0169586, filed on Nov. 25, 2024, the entire contents of which are incorporated herein by reference for all purposes as if fully set forth herein.

### BACKGROUND

### 1. Technical Field

Embodiments of the present disclosure relate to a display device.

### 2. Description of Related Art

As the information society develops, the demand for display devices for displaying images is increasing in various forms, and recently, various display devices such as a liquid crystal display device and an organic light-emitting display device are being utilized.

A display device may be a flexible display device capable of bending or folding.

The description of related art should not be considered prior art merely because it is mentioned in or associated with this section. The description of related art includes information that describes one or more aspects of the subject technology, and the description in this section does not limit the scope of the invention.

### SUMMARY

Embodiments of the present disclosure may provide a foldable display device having a plurality of display areas.

Embodiments of the present disclosure may provide a foldable display device and capable of detecting a touch by including a plurality of display areas.

Embodiments of the present disclosure may provide a display device with a new foldable structure capable of enabling the low power consumption.

Embodiments of the present disclosure may provide a display device including a substrate, a plurality of display areas, an area between the plurality of display areas, wherein the area is bendable, a plurality of drivers disposed on the substrate and positioned in the plurality of display areas, a plurality of light emitting devices positioned on the plurality of drivers and overlapping with the plurality of drivers, a plurality of column lines electrically connected to a first electrode of each of the plurality of light emitting devices, and a plurality of row lines electrically connected to a second electrode of each of the plurality of light emitting devices, wherein the display device includes a first display area including a first surface on which an image is displayed and a second surface opposite the first surface, a second display area spaced apart from the first display area, and including a third surface on which an image is displayed and a fourth surface opposite the third surface, a third display area overlapping with the second display area, and including a fifth surface and a sixth surface on which an image is displayed, and a first bending area between the first display area and the second display area, wherein the first surface and the third surface are continuous surfaces, and the second surface and the fourth surface are continuous surfaces, and wherein the third display area overlaps with the second display area.

Embodiments of the present disclosure may provide a display device including a substrate, a plurality of display areas, an area between the plurality of display areas, wherein the area is bendable, a plurality of light emitting devices positioned on a plurality of drivers disposed on the substrate, a plurality of column lines electrically connected to a first electrode of each of the plurality of light emitting devices, and a plurality of row lines electrically connected to a second electrode of each of the plurality of light emitting devices, wherein a touch driving signal is supplied to at least some of the plurality of row lines during a touch sensing period, wherein the display device includes a first display area including a first surface on which an image is displayed and a second surface opposite the first surface, a second display area spaced apart from the first display area, and including a third surface on which an image is displayed and a fourth surface opposite the third surface, a third display area overlapping with the second display area, and including a fifth surface and a sixth surface on which an image is displayed, and a first bending area between the first display area and the second display area, wherein the first surface and the third surface are continuous surfaces, and the second surface and the fourth surface are continuous surfaces, and wherein the third display area overlaps with the second display area.

According to embodiments of the present disclosure, it is possible to provide a foldable display device having a plurality of display areas.

According to embodiments of the present disclosure, it is possible to provide a foldable display device and capable of detecting a touch by including a plurality of display areas.

According to embodiments of the present disclosure, it is possible to provide a display device with a new foldable structure capable of enabling the low power consumption.

The effects of the embodiments of the present disclosure are not limited to the effects described above, and other effects not mentioned may be clearly understood by those skilled in the art from the description of the claims.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure.

FIG. 1 illustrates a display device according to embodiments of the present disclosure.

FIG. 2 is a plan view of a display device according to embodiments of the present disclosure.

FIG. 3 is a plan view of a display panel according to embodiments of the present disclosure.

FIG. 4 illustrates a sub-pixel of a display panel according to embodiments of the present disclosure.

FIG. 5 is a plan view of a display panel according to embodiments of the present disclosure.

FIG. 6 illustrates a unit driving area of a display panel according to embodiments of the present disclosure.

FIG. 7 and FIG. 8 are plan views of a portion of a display panel according to embodiments of the present disclosure.

FIG. 9 is a cross-sectional view of a display panel according to embodiments of the present disclosure.

FIG. 10 is a detailed cross-sectional view of a display panel according to embodiments of the present disclosure, taken along the A-B cutting line of FIG. 5.

FIG. 11 is an enlarged cross-sectional view of a first sub-pixel of a display panel according to embodiments of the present disclosure.

FIG. 12 briefly illustrates a touch sensing structure of a display device according to embodiments of the present disclosure.

FIGS. 13 and 14 illustrate a touch driving structure of a display panel according to embodiments of the present disclosure.

FIGS. 15 and 16 are driving timing diagrams of a display device according to embodiments of the present disclosure.

FIG. 17 is a cross-sectional view of a foldable display device according to embodiments of the present disclosure.

FIG. 18 is a cross-sectional view of a display device for a second display area and a third display area according to embodiments of the present disclosure.

FIG. 19 illustrates a touch operation of a display device according to embodiments of the present disclosure.

FIG. 20 illustrates a hover touch operation of a display device according to embodiments of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description may make the subject matter in some embodiments of the present invention rather unclear. The terms such as “including”, “having”, “containing”, “constituting”, “make up of”, and “formed of” used herein are generally intended to allow other components to be added unless the terms are used with the term “only”. As used herein, singular forms are intended to include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise.

Terms, such as “first”, “second”, “A”, “B”, “(A)”, or “(B)” may be used herein to describe elements of the present invention. Each of these terms is not used to define essence, order, sequence, or number of elements etc., but is used merely to distinguish the corresponding element from other elements.

When it is mentioned that a first element “is connected or coupled to”, “contacts or overlaps”, etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosure are described in detail with reference to the accompanying drawings.

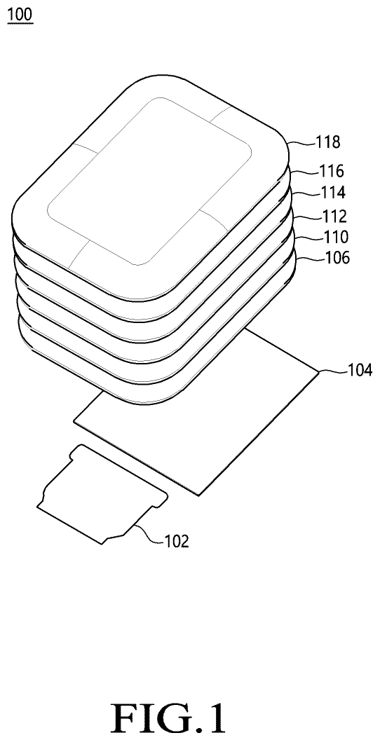

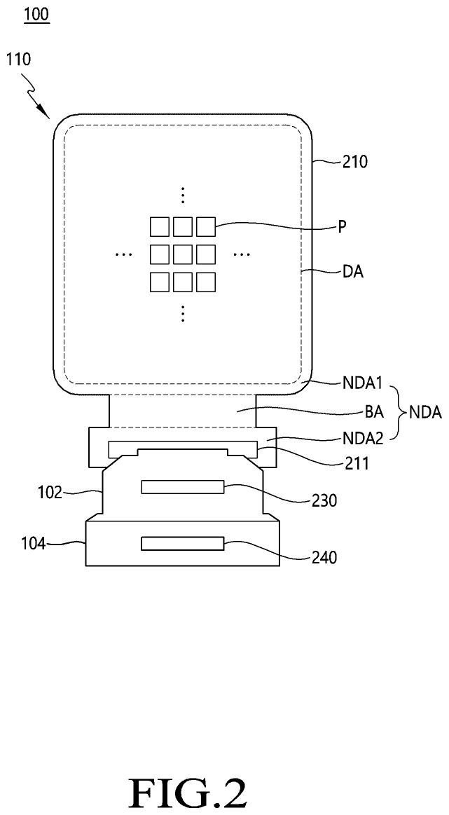

FIG. 1 illustrates a display device 100 according to embodiments of the present disclosure, and FIG. 2 is a plan view of a display device 100 according to embodiments of the present disclosure.

Referring to FIG. 1, a display device 100 according to the embodiments of the present disclosure may include a display panel 110, a cover member 118 disposed on the display panel 110, a flexible printed circuit 102 connected to the display panel 110, and a printed circuit board 104 connected to the flexible printed circuit 102.

The display device 100 according to the embodiments of the present disclosure may further include a support substrate 106 disposed under the display panel 110 and supporting the lower portion of the display panel 110, a polarizing layer 114 disposed on the display panel 110, a first adhesive layer 112 disposed between the display panel 110 and the polarizing layer 114, and a second adhesive layer 116 disposed between the polarizing layer 114 and the cover member 118.

The display panel 110 may include a substrate 210. The substrate 210 may be a member on which various components such as a plurality of metal layers and a plurality of insulating material layers are formed. The substrate 210 may be made of an insulating material. For example, the substrate 210 may be made of glass or resin. In addition, the substrate 210 may be made of a flexible material. For example, the substrate 210 may be made of a flexible plastic material such as polyimide (PI). However, the embodiments of the present disclosure are not limited thereto.

The display panel 110 may display information, videos, and/or images to a user. For example, the display panel 110 may include a display area DA and a non-display area NDA. For example, the substrate 210 may include a display area DA and a non-display area NDA. The display area DA and the non-display area NDA are not limited to the substrate 210, but can be described throughout the entire display device 100.

The display area DA may be an area where an image is displayed. The display area DA may include a plurality of pixels P. Each of the plurality of pixels P may be composed of a plurality of sub-pixels. At least one light emitting device may be arranged in each of the plurality of sub-pixels. The light emitting device may be configured differently depending on the type of the display device 100. For example, if the display device 100 is an inorganic light emitting display device, the light emitting device may be an inorganic-based light emitting device, such as a light emitting diode (LED), a micro LED, or a mini LED, but the embodiments of the present disclosure are not limited thereto.

The non-display area NDA may be an area where an image is not displayed. In the non-display area NDA, various wirings, and circuits for driving a plurality of pixels P of the display area DA may be arranged. For example, various driving circuits and various wirings may be arranged in the non-display area NDA, and a pad section 211 to which an integrated circuit and a printed circuit are connected may be arranged, but the embodiments of the present disclosure are not limited thereto.

According to the present embodiments, the non-display area NDA may include a first non-display area NDA1, a bending area BA, and a second non-display area NDA2.

The display area DA of the substrate 210 or the display device 100 may be configured in various shapes according to the design of the display device 100.

According to the embodiments of the present disclosure, a width of the second non-display area NDA2 where the pad section 211 is arranged may be wider than a width of the bending area BA. In addition, a width of the display area DA may be wider than the width of the bending area BA. In the drawing, the width of the bending area BA is depicted as being narrower than the width of other areas of the substrate 210, but the shape of the substrate 210 including the bending area BA is an example, and the embodiments of the present disclosure are not limited thereto.

Referring to FIG. 1 and FIG. 2, a flexible printed circuit 102 and a printed circuit board 104 may be disposed at a lower portion of the display panel 110. The flexible printed circuit 102 and the printed circuit board 104 may be arranged at one edge of the display panel 100, but the embodiments of the present disclosure are not limited thereto. One side of the flexible printed circuit 102 may be connected to the display panel 110, and the other side may be connected to the printed circuit board 104, but the embodiments of the present disclosure are not limited thereto. The flexible printed circuit 102 may be a flexible film, but the embodiments of the present disclosure are not limited thereto.

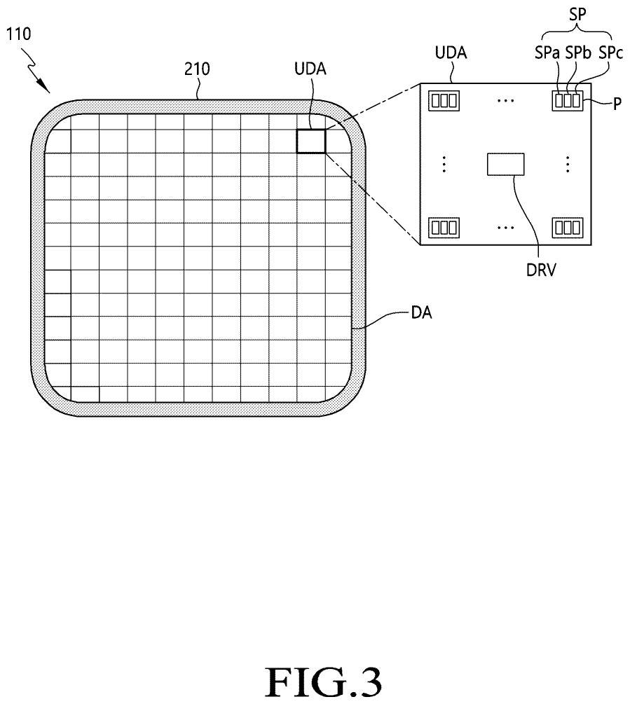

The pad section 211 disposed in the second non-display area NDA2 includes a plurality of pads, and a driving component including one or more flexible printed circuits 102 and a printed circuit board 104 can be attached or bonded. The plurality of pads included in the pad section 211 are electrically connected to one or more flexible printed circuits 102, and may transmit various signals (or power) from the printed circuit board 104 and one or more flexible printed circuits 102 to a driving circuit (for example, a driver DRV of FIG. 3) arranged in the display area DA.

The flexible printed circuit 102 may be a film in which various components are arranged on a flexible base film. For example, a first circuit component 230, such as a gate drive integrated circuit and/or a data drive integrated circuit, may be arranged on one or more flexible printed circuits 102, but the embodiments of the present disclosure are not limited thereto. The first circuit component 230 may be a component that processes data and a driving signal for displaying an image.

The printed circuit board 104 may be a component that is electrically connected to the flexible printed circuit 102 and supplies a signal to the first circuit component 230. The printed circuit board 104 may be arranged on one side of the flexible printed circuit 102 and may be electrically connected to the flexible printed circuit 102. Various components for supplying various signals to the first circuit component 230 may be arranged on the printed circuit board 104.

The printed circuit board 104 may include at least one hole, but the embodiments of the present disclosure are not limited thereto. An internal component detecting ambient light or temperature, such as a plurality of sensors, may be arranged in an area corresponding to at least one hole.

Referring to FIG. 1, a polarizing layer 114 may be arranged on a display panel 110 and may prevent or reduce light generated from an external light source from entering the display panel 110 and affecting a light emitting device.

A cover member 118 may be arranged on a polarizing layer 114 and may be a member for protecting the display panel 110.

A second adhesive layer 116 may be disposed between the polarizing layer 114 and the cover member 118. The second adhesive layer 116 may attach the cover member 118 to the display panel 110 or the polarizing layer 114.

A first adhesive layer 112 may be disposed between the display panel 110 and the polarizing layer 114. The first adhesive layer 112 may attach the polarizing layer 114 to the display panel 110. The first adhesive layer 112 may be omitted.

Each of the first adhesive layer 112 and the second adhesive layer 116 may include an optically clear adhesive (OCA), an optically clear resin (OCR), or a pressure sensitive adhesive (PSA), but the embodiments of the present disclosure are not limited thereto.

The support substrate 106 is disposed between the display panel 110 and the printed circuit board 104 to reinforce the rigidity of the display panel 110. The support substrate 106 may be a back plate, but the embodiments of the present disclosure are not limited thereto.

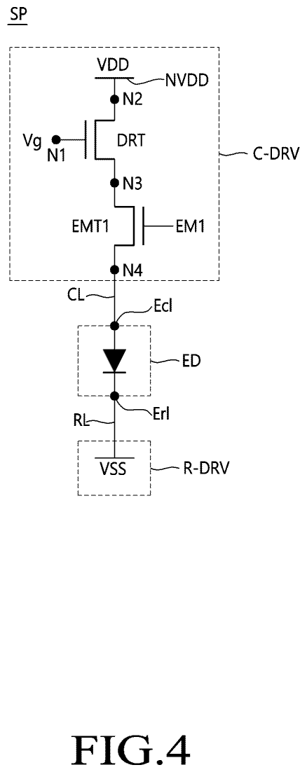

FIG. 3 is a plan view of a display panel 110 according to embodiments of the present disclosure, and FIG. 4 is a plan view of a unit driving area UDA of a display panel 110 according to embodiments of the present disclosure.

Referring to FIG. 3, the display area DA of the display panel 110 according to the embodiments of the present disclosure may include a plurality of unit driving areas UDA.

Referring to FIG. 3, the display panel 110 according to the embodiments of the present disclosure may include a driver DRV arranged in each of the plurality of unit driving areas UDA.

Referring to FIG. 3, each of the plurality of unit driving areas UDA may be a driving area driven by one driver DRV. That is, the plurality of unit driving areas UDA may be independent driving areas driven by different drivers DRV.

Referring to FIG. 3, the display panel 110 according to the embodiments of the present disclosure may include a substrate 210 including a display area DA, and a plurality of pixels P arranged in a matrix form in the display area DA.

A plurality of pixels P may be arranged in each of the plurality of unit driving areas UDA. Each of the plurality of pixels P may include a plurality of sub-pixels SP. Each of the plurality of sub-pixels SP may include at least one light emitting device.

FIG. 4 illustrates a sub-pixel SP of a display panel 110 according to embodiments of the present disclosure.

Referring to FIG. 4, the sub-pixel SP according to embodiments of the present disclosure may include a light emitting device ED including a first electrode Ecl and a second electrode Erl, a column driver C-DRV for driving a column line CL electrically connected to the first electrode Ecl of the light emitting device ED, and a row driver R-DRV for driving a row line RL electrically connected to the second electrode Erl of the light emitting device ED.

Referring to FIG. 4, the light emitting device ED may include a first electrode Ecl and a second electrode Erl. The first electrode Ecl may be electrically connected to a column line CL, and the second electrode Erl may be electrically connected to a row line RL. For example, the first electrode Ecl may be an anode electrode, and the second electrode Erl may be a cathode electrode. For another example, the first electrode Ecl may be a cathode electrode, and the second electrode Erl may be an anode electrode.

Referring to FIG. 4, a column driver C-DRV included in a unit driving area UDA may be connected to a plurality of column lines CL included in the unit driving area UDA, and may drive a plurality of column lines CL included in the unit driving area UDA. Each of the plurality of column lines CL may be commonly connected to the first electrode Ecl of each of the plurality of light emitting devices ED included in the plurality of sub-pixels SP arranged in the corresponding column.

Referring to FIG. 4, a row driver R-DRV included in a unit driving area UDA may be connected to a plurality of row lines RL included in the unit driving area UDA and may drive a plurality of row lines RL included in the unit driving area UDA. Each of the plurality of row lines RL may be commonly connected to a second electrode Erl of each of a plurality of light emitting devices ED included in a plurality of sub-pixels SP arranged in the corresponding row.

Referring to FIG. 4, the column driver C-DRV may include main nodes including a first node N1, a second node N2, a third node N3, and a fourth node N4. The column driver C-DRV may include a driving transistor DRT and a first emission control transistor EMT1.

The first node N1 may be a node to which a voltage Vg for controlling the on-off of the driving transistor DRT is applied. The second node N2 may be a node electrically connected to a high-potential voltage node NVDD to which a high-potential voltage VDD is applied. The third node N3 may be a node to which the driving transistor DRT and the first emission control transistor EMT1 are connected. The fourth node N4 may be a node to which the first emission control transistor EMT1 and the light emitting device ED are electrically connected, and may be a node to which the column line CL is electrically connected. Here, a source electrode or a drain electrode of the first emission control transistor EMT1 and the first electrode Ecl of the light emitting device ED may be commonly connected to the column line CL.

The driving transistor DRT supplies a driving current to make the light emitting device ED emit light, is connected between the second node N2 and the third node N3, and may control the connection between the second node N2 and the third node N3 according to the voltage of the first node N1.

The gate electrode of the driving transistor DRT is electrically connected to the first node N1, and a gate voltage Vg may be applied thereto. The drain electrode or the source electrode of the driving transistor DRT may be electrically connected to the second node N2. The source electrode or the drain electrode of the driving transistor DRT may be electrically connected to the third node N3.

The first emission control transistor EMT1 may control a connection of a path through which the driving current flows, and may play a role in controlling an emission of the light emitting device ED.

If the driving transistor DRT and the first emission control transistor EMT1 are turned on between a high potential voltage VDD and a low-potential voltage VSS, the driving current can be supplied to the light emitting device ED through the driving transistor DRT and the first emission control transistor EMT1. Accordingly, the light emitting device ED can emit light.

The first emission control transistor EMT1 is connected between the third node N3 and the fourth node N4, and can control the connection between the third node N3 and the fourth node N4 according to a first emission control signal EM1. The first emission control signal EM1 may be applied to the gate electrode of the first emission control transistor EMT1. The drain electrode or the source electrode of the first emission control transistor EMT1 may be electrically connected to the third node N3. The source electrode or drain electrode of the first emission control transistor EMT1 may be electrically connected to the fourth node N4.

The first emission control signal EM1 may be a pulse width modulation signal that varies at a predefined time (for example, each frame, or each sub-frame included in one frame), but the embodiments of the present disclosure are not limited thereto.

The first emission control signal EM1 may be generated by the driver DRV, or may be supplied to the driver DRV from a driving-related circuit such as a timing controller. For example, if the first emission control signal EM1 is a pulse width modulation signal, the first emission control signal EM1 may have a pulse width corresponding to an image signal (e.g., data voltage, data signal). For example, if the pulse width of the first emission control signal EM1 is large, the emission luminance of the light emitting device ED may be high. If the pulse width of the first emission control signal EM1 is small, the emission luminance of the light emitting device ED may be low.

Referring to FIG. 4, the row driver R-DRV may drive at least one row line RL by supplying a low-potential voltage VSS to at least one row line RL.

The row driver R-DRV may perform display-on driving or display-off driving for one row line RL. The row driver R-DRV may supply a low-potential voltage for display-on driving to one row line RL in order to perform display-on driving for one row line RL. The row driver R-DRV may supply a low-potential voltage for display-off driving to one row line RL in order to perform display-off driving for one row line RL.

A low-potential voltage for display-on driving and a low-potential voltage for display-off driving may be different. For example, the low-potential voltage for display-on driving may be lower than the low-potential voltage for display-off driving. In the embodiments of the present disclosure, the “low-potential voltage for display-on driving” is also referred to as the “first low-potential voltage”, and the “low-potential voltage for display-off driving” is also referred to as the “second low-potential voltage”.

Referring to FIG. 4, the column driver C-DRV may further include at least one switching element and/or at least one transistor in addition to the driving transistor DRT and the first emission control transistor EMT1. Each of the transistors included in the column driver C-DRV may be an n-type transistor or a p-type transistor.

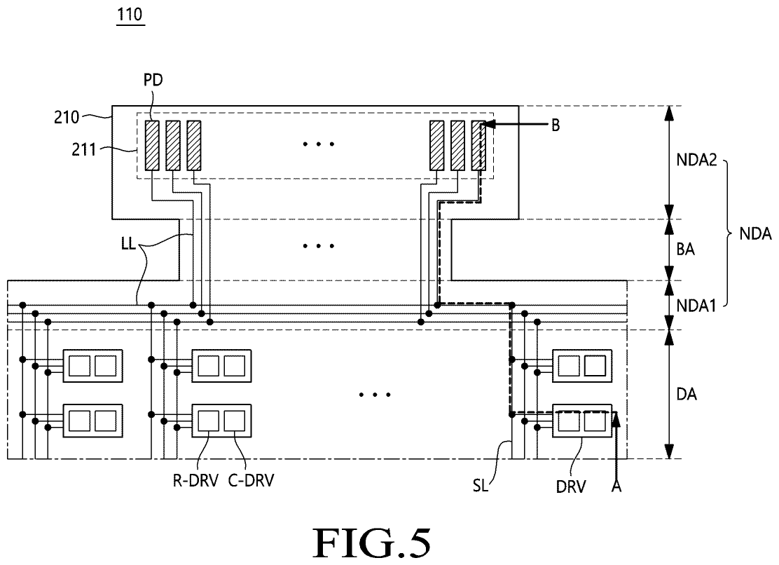

FIG. 5 is a plan view of the display panel 110 according to the embodiments of the present disclosure.

Referring to FIG. 5, the substrate 210 of the display panel 110 according to the embodiments of the present disclosure may include a display area DA and a non-display area NDA, and the non-display area NDA may include a first non-display area NDA1, a bending area BA, and a second non-display area NDA2.

Referring to FIG. 5, a plurality of drivers DRV may be arranged in the display area DA. Each of the plurality of drivers DRV may be a circuit for driving light emitting devices of a plurality of sub-pixels included in a corresponding unit driving area (UDA of FIG. 4). Each of the plurality of drivers DRV may include a row driver R-DRV for driving a plurality of row lines and a column driver C-DRV for driving a plurality of column lines, in order to drive a plurality of light emitting devices ED included in a corresponding unit driving area (UDA of FIG. 4).

Referring to FIG. 5, a pad section 211 including a plurality of pads PD may be arranged in the second non-display area NDA2.

Referring to FIG. 5, a plurality of signal lines SL and a plurality of link lines LL for signal transmission between a plurality of drivers DRV arranged in the display area DA and the pad section 211 may be arranged on the substrate 210. The plurality of signal lines SL may be electrically connected between the plurality of link lines LL and the plurality of drivers DRV. The plurality of link lines LL may electrically connect the plurality of pads PD and the plurality of signal lines SL.

Referring to FIG. 5, the plurality of link lines LL may be arranged in the non-display area NDA, and all or part of each of the plurality of signal lines SL may be arranged in the display area DA.

Each of the plurality of drivers DRV may receive various signals to perform a driving operation through the plurality of link lines LL and the plurality of signal lines SL. Here, the various signals may include various power voltages and various signals required for the driving operation of each of the plurality of drivers DRV.

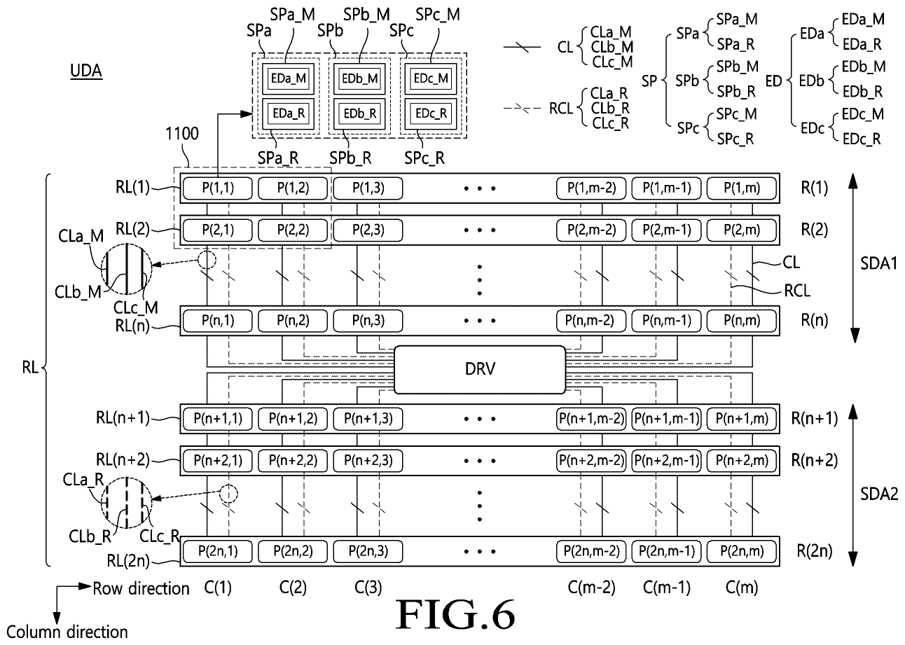

FIG. 6 illustrates a unit driving area UDA of a display panel 110 according to embodiments of the present disclosure.

Referring to FIG. 6, the display panel 110 according to embodiments of the present disclosure may include a plurality of pixels P, a plurality of row lines RL, and a plurality of column lines CL.

According to the example of FIG. 6, the plurality of pixels P may include pixels P(1,1), . . . , P(1,m), P(2,1), . . . , P(2,m), . . . , P(2n,1), . . . , P(2n,m) of (2n×m) pixels arranged in the unit driving area UDA. The plurality of row lines RL may include 2n row lines RL(1) to RL(2n) arranged in the unit driving area UDA.

The display panel 110 according to the embodiments of the present disclosure may include a redundancy structure. According to the redundancy structure, each of the plurality of pixels P may include k main sub-pixels and k redundancy sub-pixels. Each of the k main sub-pixels may include a main light emitting device, and each of the k redundancy sub-pixels may include a redundancy light emitting device. In other words, each of the plurality of pixels P may include k main light emitting devices EDa_M, EDb_M and EDc_M and k redundancy light emitting devices EDa_R, EDb_R and EDc_R.

Referring to FIG. 6, each of the plurality of pixels P(1,1), . . . , P(1,m), P(2,1), . . . , P(2,m), . . . , P(2n,1), . . . , P(2n,m) may include a first sub-pixel SPa, a second sub-pixel SPb, and a third sub-pixel SPc.

The first sub-pixel SPa may include a first main sub-pixel SPa_M and a first redundancy sub-pixel SPa_R. The first main sub-pixel SPa_M may include a first main light emitting device EDa_M, and the first redundancy sub-pixel SPa_R may include a first redundancy light emitting device EDa_R.

The first sub-pixel SPa may include a first light emitting device EDa that emits a first color light, and the first light emitting device EDa may include a first main light emitting device EDa_M and a first redundancy light emitting device EDa_R.

The second sub-pixel SPb may include a second main sub-pixel SPb_M and a second redundancy sub-pixel SPb_R. The second main sub-pixel SPb_M may include a second main light emitting device EDb_M, and the second redundancy sub-pixel SPb_R may include a second redundancy light emitting device EDb_R.

The second sub-pixel SPb may include a second light emitting device EDb that emits second color light, and the second light emitting device EDb may include a second main light emitting device EDb_M and a second redundancy light emitting device EDb_R.

The third sub-pixel SPc may include a third main sub-pixel SPc_M and a third redundancy sub-pixel SPc_R. The third main sub-pixel SPc_M may include a third main light emitting device EDc_M, and the third redundancy sub-pixel SPc_R may include a third redundancy light emitting device EDc_R.

The third sub-pixel SPc may include a third light emitting device EDc that emits a third color light, and the third light emitting device EDc may include a third main light emitting device EDc_M and a third redundancy light emitting device EDc_R.

Referring to FIG. 6, the plurality of column lines CL may include a plurality of main column lines CLa_M, CLb_M and CLc_M and a plurality of redundancy column lines CLa_R, CLb_R and CLc_R.

In each of the plurality of columns (i.e., a plurality of pixel columns) included in each of the first sub-driving area SDA and the second sub-driving area SDA2, k main column lines CLa_M, CLb_M and CLc_M, and k redundancy column lines CLa_R, CLb_R and CLc_R may be arranged.

In each column (i.e., each pixel column), k main column lines CLa_M, CLb_M and CLc_M may be connected to the first electrodes Ecl of k main light emitting devices EDa_M, EDb_M and EDc_M.

In each column (i.e., each pixel column), k redundancy column lines CLa_R, CLb_R and CLc_R may be connected to the first electrodes Ecl of k redundancy light emitting devices EDa_R, EDb_R and EDc_R.

Since this redundancy structure is configurations for repair, the redundancy configurations may be excluded from the display device.

Hereinafter, in order to examine the planar structure of the display panel 110 according to the embodiments of the present disclosure in more detail, it will be described the planar structure of a portion 1100 of the planar view of FIG. 6 in more detail as an example.

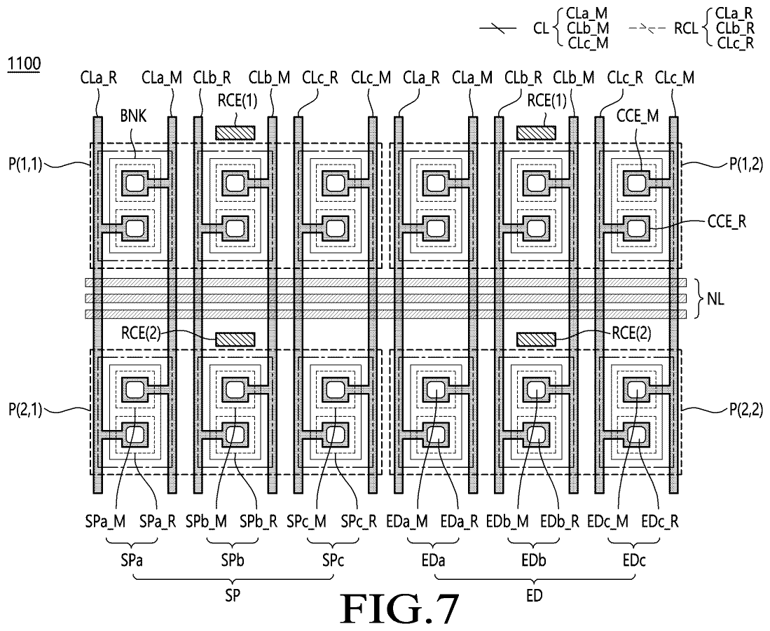

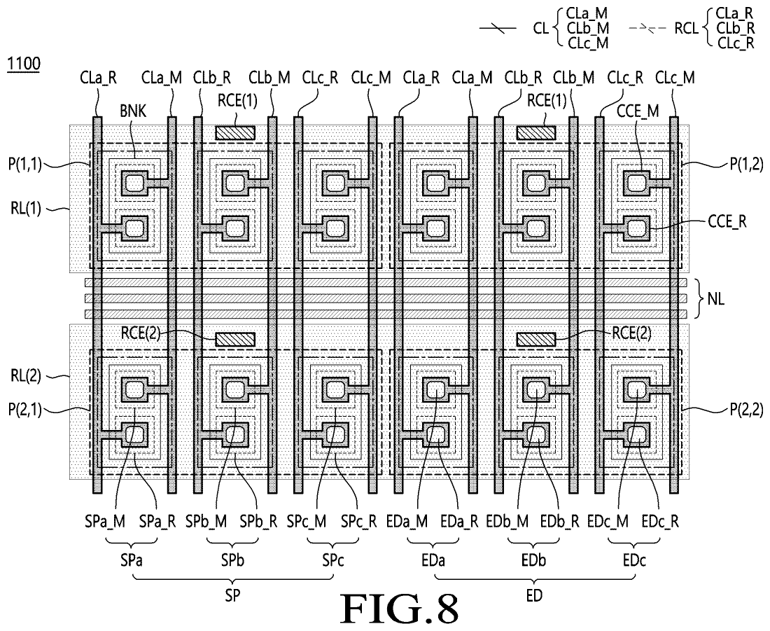

FIG. 7 and FIG. 8 are plan views of a portion 1100 of a display panel 110 according to embodiments of the present disclosure. FIG. 7 and FIG. 8 are enlarged plan views of a portion 1100 of the plan view of FIG. 6, and are enlarged plan views of a two-row, two-column area 1100.

FIG. 7 is a plan view that does not represent two row lines RL(1) and RL(2) arranged in a two-row, two-column area 1100, and FIG. 8 is a plan view in which two row lines RL(1) and RL(2) arranged in a two-row, two-column area 1100 are added to a plan view of FIG. 6.

Referring to FIG. 7 and FIG. 8, in the two-row, two-column area 1100, four pixels P(1,1), P(1,2), P(2,1), P(2,2) may be arranged in two rows and two columns. That is, in the two-row, two-column area 1100, two pixels P(1,1) and P(1,2) may be arranged in a first row (e.g., a first pixel row), and two pixels P(2,1) and P(2,2) may be arranged in a second row (e.g., a second pixel row). In addition, two pixels P(1,1) and P(2,1) may be arranged in a first column (e.g., a first pixel column), and two pixels P(1,2) and P(2,2) may be arranged in a second column (e.g., a second pixel column).

Referring to FIG. 7 and FIG. 8, in the two-row, two-column area 1100, each of the four pixels P(1,1), P(1,2), P(2,1) and P(2,2) arranged in two rows and two columns may include k sub-pixels. Here, k is the number of sub-pixels included in one pixel.

In FIG. 7 and FIG. 8, it illustrates a case where k is 3 as an example. Accordingly, in the two-row, two-column area 1100, each of the four pixels P(1,1), P(1,2), P(2,1) and P(2,2) arranged in two rows and two columns may include three sub-pixels SPa, SPb and SPc. In the following description, it may be explained assuming the case where k is 3.

The three sub-pixels may include a first sub-pixel SPa including a first light emitting device EDa that emits a first color light, a second sub-pixel SPb including a second light emitting device EDb that emits a second color light, and a third sub-pixel SPc including a third light emitting device EDc that emits a third color light.

If the display panel 110 according to the embodiments of the present disclosure has a redundancy structure, the sub-pixel redundancy structure is as follows.

The first sub-pixel SPa may include a first main sub-pixel SPa_M including a first main light emitting device EDa_M and a first redundancy sub-pixel SPa_R including a first redundancy light emitting device EDa_R, the second sub-pixel SPb may include a second main sub-pixel SPb_M including a second main light emitting device EDb_M and a second redundancy sub-pixel SPb_R including a second redundancy light emitting device EDb_R, and the third sub-pixel SPc may include a third main sub-pixel SPc_M including a third main light emitting device EDc_M and a third redundancy sub-pixel SPc_R including a third redundancy light emitting device EDc_R.

If the display panel 110 according to the embodiments of the present disclosure has a redundancy structure, the light emitting device redundancy structure is as follows.

The first light emitting device EDa may include a first main light emitting device EDa_M that emits a first color light and a first redundancy light emitting device EDa_R that emits a first color light, the second light emitting device EDb may include a second main light emitting device EDb_M that emits a second color light and a second redundancy light emitting device EDb_R that emits a second color light, and the third light emitting device EDb may include a third main light emitting device EDc_M that emits a third color light and a third redundancy light emitting device EDc_R that emits a third color light.

Referring to FIG. 7 and FIG. 8, in the two-row, two-column area 1100, a first row line RL(1) and a second row line RL(2) may be arranged. The first row line RL(1) may be arranged in the first row (i.e., the first pixel row), and the second row line RL(2) may be arranged in the second row (i.e., the second pixel row).

The first row line RL(1) may correspond to two pixels P(1,1) and P(1,2) arranged in the first row (or the first pixel row), and may correspond to three sub-pixels SPa, SPb and SPc included in each of the two pixels P(1,1) and P(1,2) arranged in the first row (or the first pixel row).

In terms of the sub-pixel redundancy structure, the first row line RL(1) may be connected to the first main sub-pixel SPa_M, the first redundancy sub-pixel SPa_R, the second main sub-pixel SPb_M, the second redundancy sub-pixel SPb_R, the third main sub-pixel SPc_M, and the third redundancy sub-pixel SPc_R arranged in the first row (or the first pixel row).

At least a portion of the first row line RL(1) may overlap with the first main sub-pixel SPa_M, the first redundancy sub-pixel SPa_R, the second main sub-pixel SPb_M, the second redundancy sub-pixel SPb_R, the third main sub-pixel SPc_M, and the third redundancy sub-pixel SPc_R arranged in the first row (or the first pixel row).

From the perspective of the light emitting device redundancy structure, the first row line RL(1) may be connected to the second electrode Erl of each of the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the first row (or the first pixel row).

At least a part of the first row line RL(1) may overlap with the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the first row (or the first pixel row).

The second row line RL(2) may correspond to two pixels P(2,1) and P(2,2) arranged in a second row (or the second pixel row), and may correspond to three sub-pixels SPa, SPb and SPc included in each of the two pixels P(2,1) and P(2,2) arranged in the second row (or the second pixel row).

In terms of the sub-pixel redundancy structure, the second row line RL(2) may be connected to the first main sub-pixel SPa_M, the first redundancy sub-pixel SPa_R, the second main sub-pixel SPb_M, the second redundancy sub-pixel SPb_R, the third main sub-pixel SPc_M, and the third redundancy sub-pixel SPc_R arranged in the second row (or the second pixel row).

At least a portion of the second row line RL(2) may overlap with the first main sub-pixel SPa_M, the first redundancy sub-pixel SPa_R, the second main sub-pixel SPb_M, the second redundancy sub-pixel SPb_R, the third main sub-pixel SPc_M, and the third redundancy sub-pixel SPc_R arranged in the second row (or the second pixel row).

In terms of the light emitting device redundancy structure, the second row line RL(2) may be connected to the second electrode Erl of each of the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the second row (or the second pixel row).

At least a portion of the second row line RL(2) may overlap with the first main light emitting device EDa_M, the first redundancy light emitting device EDa_R, the second main light emitting device EDb_M, the second redundancy light emitting device EDb_R, the third main light emitting device EDc_M, and the third redundancy light emitting device EDc_R arranged in the second row (or the second pixel row).

Referring to FIG. 7 and FIG. 8, a plurality of column lines CL may be arranged in the two-row two-column area 1100. A plurality of column lines CL arranged in a two-row two-column area 1100 may include a plurality of first column lines CL connected to two pixels P(1,1) and P(2,1) arranged in a first column (or a first pixel column), and a plurality of second column lines CL connected to two pixels P(1,2) and P(2,2) arranged in a second column (or a second pixel column).

Referring to FIGS. 7 and 8, from the perspective of sub-pixel redundancy, a plurality of first column lines CL arranged in a first column (or first pixel column) may include a first main column line CLa_M that is commonly connected to a first main sub-pixel SPa_M included in each of two pixels P(1,1)and P(2,1) arranged in the first column (or first pixel column), and a first redundancy column line CLa_R that is commonly connected to a first redundancy sub-pixel SPa_R included in each of two pixels P(1,1) and P(2,1) arranged in the first column (or first pixel column).

The first main sub-pixel SPa_M included in each of the two pixels P(1,1) and P(2,1) arranged in the first column (or the first pixel column) may include a first main light emitting device EDa_M, and the first redundancy sub-pixel SPa_R included in each of the two pixels P(1,1) and P(2,1) arranged in the first column (or the first pixel column) may include a first redundancy light emitting device (EDa_R).

The first main column line CLa_M arranged in the first column (or the first pixel column) may be commonly connected to the first electrodes Ecl of the two first main light emitting devices EDa_M arranged in the first column (or the first pixel column).

The first redundancy column line CLa_R arranged in the first column (or the first pixel column) may be commonly connected to the first electrodes Ecl of two first redundancy light emitting devices EDa_R arranged in the first column (or the first pixel column).

In addition, the plurality of first column lines CL arranged in the first column (or the first pixel column) may further include a second main column line CLb_M commonly connected to a second main sub-pixel SPb_M included in each of the two pixels P(1,1) and P(2,1) arranged in the first column (or the first pixel column), and a second redundancy column line CLb_R commonly connected to a second redundancy sub-pixel SPb_R included in each of the two pixels P(1,1) and P(2,1) arranged in the first column (or the first pixel column).

The second main sub-pixel SPb_M included in each of the two pixels P(1,1) and P(2,1) arranged in the first column (or the first pixel column) may include a second main light emitting device EDb_M, and the second redundancy sub-pixel SPb_R included in each of the two pixels P(1,1) and P(2,1) arranged in the first column (or the first pixel column) may include a second redundancy light emitting device EDb_R.

The second main column line CLb_M arranged in the first column (or the first pixel column) may be commonly connected to the first electrodes Ecl of the two second main light emitting devices EDb_M arranged in the first column (or the first pixel column).

The second redundancy column line CLb_R arranged in the first column (or the first pixel column) may be commonly connected to the first electrodes Ecl of the two second redundancy light emitting devices EDb_R arranged in the first column (or the first pixel column).

In addition, the plurality of first column lines CL arranged in the first column (or the first pixel column) may further include a third main column line CLc_M commonly connected to the third main sub-pixel SPc_M included in each of the two pixels P(1,1) and P(2,1) arranged in the first column (or the first pixel column), and a third redundancy column line CLc_R commonly connected to the third redundancy sub-pixel SPc_R included in each of the two pixels P(1,1) and P(2,1) arranged in the first column (or the first pixel column).

The third main sub-pixel SPc_M included in each of the two pixels P(1,1) and P(2,1) arranged in the first column (or the first pixel column) may include a third main light emitting device EDc_M, and the third redundancy sub-pixel SPc_R included in each of the two pixels P(1,1) and P(2,1) arranged in the first column (or the first pixel column) may include a third redundancy light emitting device EDc_R.

The third main column line CLc_M arranged in the first column (or the first pixel column) may be commonly connected to the first electrodes Ecl of the two third main light emitting devices EDc_M arranged in the first column (or the first pixel column).

The third redundancy column line CLc_R arranged in the first column (or the first pixel column) may be commonly connected to the first electrodes Ecl of two third redundancy light emitting devices EDc_R arranged in the first column (or the first pixel column).

Referring to FIGS. 7 and 8, from the perspective of sub-pixel redundancy, a plurality of second column lines CL arranged in a second column (or second pixel column) may include a first main column line CLa_M that is commonly connected to a first main sub-pixel SPa_M included in each of two pixels P(1,2) and P(2,2) arranged in the second column (or second pixel column), and a first redundancy column line CLa_R that is commonly connected to a first redundancy sub-pixel SPa_R included in each of two pixels P(1,2) and P(2,2) arranged in the second column (or second pixel column).

The first main sub-pixel SPa_M included in each of the two pixels P(1,2) and P(2,2) arranged in the second column (or the second pixel column) may include a first main light emitting device EDa_M, and the first redundancy sub-pixel SPa_R included in each of the two pixels P(1,2) and P(2,2) arranged in the second column (or the second pixel column) may include a first redundancy light emitting device EDa_R.

The first main column line CLa_M arranged in the second column (or the second pixel column) may be commonly connected to the first electrodes Ecl of the two first main light emitting devices EDa_M arranged in the second column (or the second pixel column).

The first redundancy column line CLa_R arranged in the second column (or the second pixel column) may be commonly connected to the first electrodes Ecl of the two first redundancy light emitting devices EDa_R arranged in the second column (or the second pixel column).

In addition, the plurality of second column lines CL arranged in the second column (second pixel column) may further include a second main column line CLb_M commonly connected to a second main sub-pixel SPb_M included in each of two pixels P(1,2) and P(2,2) arranged in the second column (or second pixel column), and a second redundancy column line CLb_R commonly connected to a second redundancy sub-pixel SPb_R included in each of two pixels P(1,2) and P(2,2) arranged in the second column (or second pixel column).

The second main sub-pixel SPb_M included in each of the two pixels P(1,2) and P(2,2) arranged in the second column (or the second pixel column) may include a second main light emitting device EDb_M, and the second redundancy sub-pixel SPb_R included in each of the two pixels P(1,2) and P(2,2) arranged in the second column (or the second pixel column) may include a second redundancy light emitting device EDb_R.

The second main column line CLb_M arranged in the second column (or the second pixel column) may be commonly connected to the first electrodes Ecl of the two second main light emitting devices EDb_M arranged in the second column (or the second pixel column).

The second redundancy column line CLb_R arranged in the second column (or the second pixel column) may be commonly connected to the first electrodes Ecl of two second redundancy light emitting devices EDb_R arranged in the second column (or the second pixel column).

In addition, the plurality of first column lines CL arranged in the second column (or the second pixel column) may further include a third main column line CLc_M commonly connected to a third main sub-pixel SPc_M included in each of two pixels P(1,2) and P(2,2) arranged in the second column (or the second pixel column), and a third redundancy column line CLc_R commonly connected to a third redundancy sub-pixel SPc_R included in each of two pixels P(1,2) and P(2,2) arranged in the second column (or the second pixel column).

The third main sub-pixel SPc_M included in each of the two pixels P(1,2) and P(2,2) arranged in the second column (or the second pixel column) may include a third main light emitting device EDc_M, and the third redundancy sub-pixel SPc_R included in each of the two pixels P(1,2) and P(2,2) arranged in the second column (or the second pixel column) may include a third redundancy light emitting device EDc_R.

The third main column line CLc_M arranged in the second column (or the second pixel column) may be commonly connected to the first electrodes Ecl of the two third main light emitting devices EDc_M arranged in the second column (or the second pixel column).

The third redundancy column line CLc_R arranged in the second column (or the second pixel column) may be commonly connected to the first electrodes Ecl of two third redundancy light emitting devices EDc_R arranged in the second column (or the second pixel column).

Referring to FIGS. 7 and 8, in each of the first column (or the first pixel column) and the second column (or the second pixel column), each of the plurality of column lines CL may include at least one column connection electrode having a shape protruding above a bank BNK. For example, the at least one column connection electrode may be an electrode electrically connected to each of the plurality of column lines CL or a portion protruding from each of the plurality of column lines C.

Referring to FIGS. 7 and 8, each of the first main column line CLa_M, the second main column line CLb_M, and the third main column line CLc_M may include a main column connection electrode CCE_M protruding above the bank BNK and extending above the bank BNK.

The first main light emitting devices EDa_M, the second main light emitting devices EDb_M, and the third main light emitting devices EDc_M may be arranged on the main column connection electrodes CCE_M arranged to extend above the bank BNK.

Referring to FIGS. 7 and 8, in each of the first column (or first pixel column) and the second column (or second pixel column), each of the first redundancy column line CLa_R, the second redundancy column line CLb_R, and the third redundancy column line CLc_R may include a redundancy column connection electrode CCE_R that protrudes toward the bank BNK and extends above the bank BNK.

On the redundancy column connection electrodes CCE_R arranged to extend above the bank BNK, the first redundancy light emitting devices EDa_R, the second redundancy light emitting devices EDb_R, and the third redundancy light emitting devices EDc_R may be arranged.

The main column connection electrodes CCE_M and the redundancy column connection electrodes CCE_R arranged in the first column (or the first pixel column) may be disposed between the first main column line CLa_M and the first redundancy column line CLa_R.

The main column connection electrodes CCE_M and the redundancy column connection electrodes CCE_R arranged in the second column (or the second pixel column) may be disposed between the second main column line CLb_M and the second redundancy column line CLb_R.

The main column connection electrodes CCE_M and the redundancy column connection electrodes CCE_R arranged in the third column (or the third pixel column) may be disposed between the third main column line CLc_M and the third redundancy column line CLc_R.

The display panel 110 according to the embodiments of the present disclosure may further include at least one row connection electrode for electrically connecting each of the plurality of row lines RL to the driver DRV.

Referring to FIGS. 7 and 8, the display panel 110 according to the embodiments of the present disclosure may further include at least one first row connection electrode RCE(1) connected to a first row line RL(1) arranged in a first row (or a first pixel row), and at least one second row connection electrode RCE(2) connected to a second row line RL(2) arranged in a second row (or a second pixel row).

The first row line RL(1) may be vertically overlapped with at least one first row connection electrode RCE(1), and the second row line RL(2) may be vertically overlapped with at least one second row connection electrode RCE(2).

The first row line RL(1) may be electrically connected to the row driver R-DRV of the corresponding driver DRV through at least one first row connection electrode RCE(1). The second row line RL(2) may be electrically connected to the row driver R-DR of the corresponding driver DRV through at least one second row connection electrode RCE(2).

According to embodiments of the present disclosure, a bank BNK may be arranged in each of a plurality of sub-pixels SP. The plurality of banks BNK may be structures on which a plurality of light emitting devices ED are mounted. When manufacturing a panel, in a transfer process for transferring a plurality of light emitting devices ED to a display device 100, a plurality of banks BNK can guide the positions of the plurality of light emitting devices ED. That is, when manufacturing a panel, a plurality of light emitting devices ED can be transferred onto a plurality of banks BNK in a transfer process of the plurality of light emitting devices ED. The plurality of banks BNK may be an organic insulating layer, a bank pattern, or a structure, but the embodiments of the present disclosure are not limited thereto.

The banks BNK of each of the plurality of sub-pixels SP may be arranged to be spaced apart from each other. The banks BNK of each of the plurality of sub-pixels SP may be configured to be separated from each other. Accordingly, the banks BNK of the first sub-pixel SPa, the second sub-pixel SPb, and the third sub-pixel SPc to which different types of light emitting devices ED are transferred can be easily identified.

The bank BNK of the first main sub-pixel SPa_M and the bank BNK of the first redundancy sub-pixel SPa_R may be connected to each other, or may be formed spaced apart from each other or separately. For example, considering the design of the transfer process requirements, the bank BNK of the first main sub-pixel SPa_M and the bank BNK of the first redundancy sub-pixel SPa_R, in which light emitting devices EDa_M, EDa_R of the same type (for example, types that emit the same color light) are arranged, may be connected to each other, or may be formed spaced apart from each other or separately. In addition, the bank BNK of the second main sub-pixel SPb_M and the bank BNK of the second redundancy sub-pixel SPb_R may be connected to each other, or may be formed spaced apart from each other or separately. The bank BNK of the third main sub-pixel SPc_M and the bank BNK of the third redundancy sub-pixel SPc_R may be connected to each other, or may be formed to be spaced apart from each other.

The bank BNK of the first main sub-pixel SPa_M and the first redundancy sub-pixel SPa_R, the bank BNK of the second main sub-pixel SPb_M and the second redundancy sub-pixel SPb_R, and the bank BNK of the third main sub-pixel SPc_M and the third redundancy sub-pixel SPc_R may be formed in various ways, and the embodiments of the present disclosure are not limited thereto.

For example, the plurality of banks BNK may be formed of an organic insulating material. The plurality of banks BNK may be formed of a single layer or multiple layers of an organic insulating material. For example, the plurality of banks BNK may be composed of a photo resist, a polyimide (PI), or an acrylic material, but the embodiments of the present disclosure are not limited thereto.

The plurality of row lines RL may be formed of a transparent conductive material, but the embodiments of the present disclosure are not limited thereto. The plurality of row lines RL may be composed of a transparent conductive material so that light emitted from the light emitting devices ED may be directed upward through the row lines RL. For example, the plurality of row lines RL may be composed of a transparent conductive material such as indium tin oxide (ITO), indium zinc oxide (IZO), indium gallium zinc oxide (IGZO), and the like, but the embodiments of the present disclosure are not limited thereto.

The plurality of column lines CL may be made of a conductive material. For example, the plurality of column lines CL may be formed of a conductive material such as titanium (Ti), aluminum (Al), copper (Cu), molybdenum (Mo), nickel (Ni), chromium (Cr), indium tin oxide (ITO), indium zinc oxide (IZO), indium gallium zinc oxide (IGZO), but the embodiments of the present disclosure are not limited thereto. For another example, the plurality of column lines CL may have a multilayer structure of conductive materials. For example, the plurality of column lines CL may be made of a multilayer structure of titanium (Ti)/aluminum (Al)/titanium (Ti)/indium tin oxide (ITO), but the embodiments of the present disclosure are not limited thereto.

For example, if the light emitting device ED is a device manufactured through a semiconductor process, such as a micro LED, a plurality of light emitting devices ED may be formed on a wafer and the light emitting devices ED may be transferred to a substrate 210 of the display panel 110 to manufacture the display panel 110. In the process of transferring a plurality of light emitting devices ED having a microscopic size from the wafer to the substrate 210, various defects may occur. For example, a non-transfer defect may occur in which the light emitting device ED is not transferred in some sub-pixels SP, and a misalignment defect may occur in which the light emitting device ED is transferred out of its proper position due to an alignment error in other sub-pixels SP. In addition, the transfer process may proceed normally, but the transferred light emitting device ED itself may have a defect. Therefore, considering the defects (including non-transfer defects) that occur during the transfer process of the light emitting devices EDs, the main light emitting device and the redundancy light emitting device, which are light emitting devices of the same type (e.g., light emitting devices that emit light of the same color), can be transferred to one sub-pixel SP. A lighting test may be performed on the main light emitting device and the redundancy light emitting device of the same type, and it is possible to utilize only one of the main light emitting device and the redundancy light emitting device that is finally determined to be normal.

For example, the first main light emitting device EDa_M and the first redundancy light emitting device EDa_R may be transferred together to one first sub-pixel SPa, and the first main light emitting device EDa_M and the first redundancy light emitting device EDa_R may be inspected for defects. If, as a result of the inspection, both the first main light emitting device EDa_M and the first redundancy light emitting device EDa_R are determined to be normal, only the first main light emitting device EDa_M can be used, and the first redundancy light emitting device EDa_R may be not used. If, as a result of the inspection, only the first redundancy light emitting device EDa_R among the first main light emitting device EDa_M and the first redundancy light emitting device EDa_R is normal, the first main light emitting device EDa_M is not used, and only the first redundancy light emitting device EDa_R can be used. Accordingly, even if the same first main light emitting device EDa_M and the first redundancy light emitting device EDa_R are transferred to one first sub-pixel SPa, only one of the first main light emitting device EDa_M and the first redundancy light emitting device EDa_R can be used finally.

Accordingly, among the main light emitting device and the redundancy light emitting device arranged in one sub-pixel SP, the redundancy light emitting device may be a spare light emitting device transferred in preparation for a failure of the main light emitting device. In the event of a failure of the main light emitting device, the redundancy light emitting device can be used as a replacement. Therefore, by transferring the main light emitting device and the redundancy light emitting device together to one sub-pixel SP, it is possible to minimize the deterioration of display quality due to a defect in one of the main light emitting device and the redundancy light emitting device.

In the embodiments of the present disclosure, the first main sub-pixel SPa_M and the first redundancy sub-pixel SPa_R may also be referred to as a 1-1 sub-pixel and a 1-2 sub-pixel, respectively, the second main sub-pixel SPb_M and the second redundancy sub-pixel SPb_R may also be referred to as a 2-1 sub-pixel and a 2-2 sub-pixel, and the third main sub-pixel SPc_M and the third redundancy sub-pixel SPc_R may also be referred to as a 3-1 sub-pixel and a 3-2 sub-pixel, respectively.

In the embodiments of the present disclosure, the first main light emitting device EDa_M and the first redundancy light emitting device EDa_R may also be referred to as a 1-1 light emitting device and a 1-2 light emitting device, the second main light emitting device EDb_M and the second redundancy light emitting device EDb_R may also be referred to as a 2-1 light emitting device and a 2-2 light emitting device, and the third main light emitting device EDc_M and the third redundancy light emitting device EDc_R may also be referred to as a 3-1 light emitting device and a 3-2 light emitting device.

Referring to FIG. 7 and FIG. 8, the display panel 110 according to the embodiments of the present disclosure may further include a plurality of communication lines NL. The plurality of communication lines NL may be arranged so as not to overlap with the metal layer in a vertical direction. For example, a plurality of communication lines NL may be arranged between a first row line RL(1) and a second row line RL(2).

For example, the plurality of communication lines NL may be wires for short-range communication such as NFC (Near Field Communication) and Bluetooth. The plurality of communication lines NL may serve as signal transmission wires and/or antennas, but the embodiments of the present disclosure are not limited thereto.

Referring to FIG. 8, the first row line RL(1) may be arranged above a plurality of light emitting devices arranged in the first row (or the first pixel row) and may be arranged in a bar shape overlapping with all of the plurality of light emitting devices arranged in the first row (or the first pixel row).

The second row line RL(2) may be arranged above the plurality of light emitting devices arranged in the second row (or the second pixel row), and may be arranged in a bar shape overlapping with all of the plurality of light emitting devices arranged in the second row (or the second pixel row).

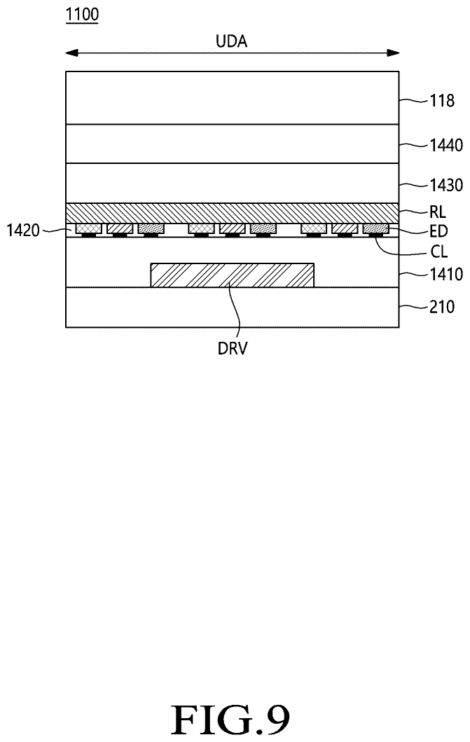

FIG. 9 is a cross-sectional view of a display panel 110 according to embodiments of the present disclosure. However, FIG. 9 is a cross-sectional view of a portion of a unit driving area UDA in which one driver DRV is arranged.

Referring to FIG. 9, a display panel 110 according to embodiments of the present disclosure may include a substrate 210, a driver DRV on the substrate 210, a layer stack 1410 on the driver DRV, a plurality of light emitting devices ED disposed on the layer stack 1410, an optical layer 1420 disposed on the layer stack 1410 and between the plurality of light emitting devices ED, an overcoat layer 1430 disposed on the plurality of light emitting devices ED and the optical layer 1420, an adhesive layer 1440 disposed on the overcoat layer 1430, and a cover member 118 disposed on the adhesive layer 1440.

The plurality of column lines CL may be arranged on a layer stack 1410. Each of the plurality of column lines CL may be arranged between the layer stack 1410 and a light emitting device ED. A plurality of row lines RL may be arranged on a plurality of light emitting devices ED and an optical layer 1420.

A display panel 110 according to embodiments of the present disclosure may include a substrate 210 including a display area DA, a plurality of light emitting devices ED arranged in the display area DA, a plurality of column lines CL electrically connected to first electrodes Ecl of each of the plurality of light emitting devices ED, a plurality of row lines RL electrically connected to second electrodes Erl of each of the plurality of light emitting devices ED, and a plurality of drivers DRV configured to drive the plurality of light emitting devices ED, the plurality of column lines CL, and the plurality of row lines RL.

A plurality of drivers DRV may be disposed in the display area DA, and may be positioned closer to the substrate 210 than the plurality of light emitting devices ED.

The layer stack 1410 may include a plurality of insulating layers. The plurality of insulating layers may include a plurality of organic layers. At least one of the plurality of organic layers may be arranged on a side of the driver DRV. For example, two or more organic layers may be arranged on a side of the driver DRV.

The layer stack 1410 may further include at least one metal layer connecting the driver DRV and the column line CL, and at least one metal layer connecting the driver DRV and the row line RL.

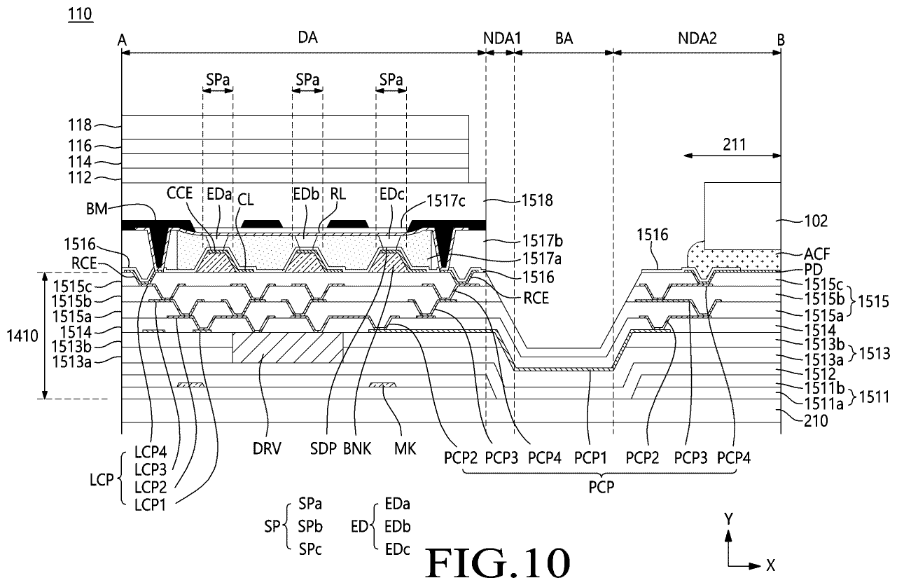

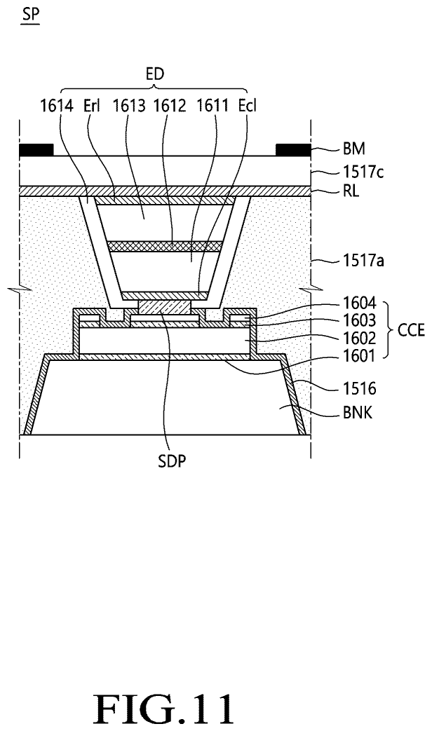

FIG. 10 is a detailed cross-sectional view of a display panel 110 according to embodiments of the present disclosure taken along the A-B cutting line of FIG. 5, and FIG. 11 is an enlarged cross-sectional view of a sub-pixel SP of a display panel 110 according to embodiments of the present disclosure. However, FIG. 10 is a cross-sectional view of a display area DA, a first non-display area NDA, a bending area BA, and a second non-display area NDA.

Meanwhile, for convenience of illustration, the A-B cutting line in FIG. 5 is illustrated as not overlapping with a signal line SL and a link line LL, but the A-B cutting line in FIG. 5 is intended to indicate the same position as the adjacent signal line SL and the link line LL.

Referring to FIG. 10, a buffer layer 1511 may be included on the substrate 210. The buffer layer 1511 may include a first buffer layer 1511a and a second buffer layer 1511b. The first buffer layer 1511a and the second buffer layer 1511b may be arranged in the display area DA, the first non-display area NDA1, and the second non-display area NDA, and may not be arranged in the entirety or part of the bending area BA. However, the present disclosure is not limited thereto.

The first buffer layer 1511a and the second buffer layer 1511b may reduce the penetration of moisture or impurities through the substrate 210. The first buffer layer 1511a and the second buffer layer 1511b may be made of an inorganic insulating material. For example, the first buffer layer 1511a and the second buffer layer 1511b may be composed of a single layer or multiple layers of silicon oxide (SiOₓ) or silicon nitride (SiNₓ), but the embodiments of the present disclosure are not limited thereto.

For example, a portion of the first buffer layer 1511a and the second buffer layer 1511b on the bending area BA may be removed. The upper surface of the substrate 210 located on the bending area BA may be exposed by the area (e.g., opening) where the first buffer layer 1511a and the second buffer layer 1511b are removed.

By removing the first buffer layer 1511a and the second buffer layer 1511b from the bending area BA, it is possible to minimize an occurrence of cracks in the first buffer layer 1511a and the second buffer layer 1511b that may occur during bending.

A plurality of alignment keys MK may be arranged between the first buffer layer 1511a and the second buffer layer 1511b. The plurality of alignment keys MK may be configured to identify the position of the driver DRV during the manufacturing process of the display panel 110. For example, the plurality of alignment keys MK may be configured to align the position of the driver DRV transferred on the adhesive layer 1512. In another example, the plurality of alignment keys MK may be omitted.

An adhesive layer 1512 may be disposed on the second buffer layer 1511b. The adhesive layer 1512 may be disposed in the display area DA, the first non-display area NDA1, the bending area BA, and the second non-display area NDA2. For another example, at least a portion of the adhesive layer 1512 may be removed in the non-display area NDA including the bending area BA. For example, the adhesive layer 1512 may be made of any one of an adhesive polymer, an epoxy resin, a UV-curable resin, a polyimide series, an acrylate series, a urethane series, and a polydimethylsiloxane (PDMS), but the embodiments of the present disclosure are not limited thereto.

A driver DRV may be disposed on the adhesive layer 1512 in the display area DA. If the driver DRV is implemented as a driving chip (e.g., driver integrated circuit), the driving driver may be mounted on the adhesive layer 1512 by a transfer process, but the embodiments of the present disclosure are not limited thereto.

The display panel 110 may further include a side protection layer 1513 disposed on the side of the plurality of drivers DRV, and an upper protection layer 1514 disposed on the plurality of drivers DRV and the side protection layer 1513.

The display panel 110 may further include a plurality of insulating layers 1515 disposed on the upper protection layer 1514.

According to embodiments of the present disclosure, in the display area DA, a plurality of line connection patterns LCP may be arranged on the second protection layer 1513b. The plurality of line connection patterns LCP may be wiring for electrically connecting the driver DRV to other components.

The display panel 110 may further include a side protection layer 1513 including at least one of the first protection layer 1513a and the second protection layer 1513b, and an upper protection layer 1514 arranged on the plurality of drivers DRV. For example, the upper protection layer 1514 may include a third protection layer 1514, and in some cases, may further include at least one additional protection layer. The third protection layer 1514 may be disposed on the second protection layer 1513b and the plurality of first line connection patterns LCP1. The third protection layer 1514 may be disposed entirely in the display area DA and the non-display area NDA. In the bending area BA, the third protection layer 1514 may cover or enclose the side surface of the second protection layer 1513b and the upper surface of the first protection layer 1513a.

A plurality of second line connection patterns LCP2 may be arranged on the third protection layer 1514. The plurality of second line connection patterns LCP2 may be electrically connected or directly connected to the driver DRV. For example, some of the second line connection patterns LCP2 may be directly or indirectly connected to the driver DRV through contact holes of the third protection layer 1514. Other parts of the second line connection patterns LCP2 may be electrically connected to the first line connection pattern LCP1 through contact holes of the third protection layer 1514. However, the embodiments of the present disclosure are not limited thereto. The voltage output from the driver DRV may be transmitted to the column line CL or the row line RL through the plurality of second line connection patterns LCP2 and other connection patterns.

A first insulating layer 1515a may be disposed on the plurality of second line connection patterns LCP2. The first insulating layer 1515a may be disposed entirely over the display area DA and the non-display area NDA, but the embodiments of the present disclosure are not limited thereto. The first insulating layer 1515a may be composed of an organic insulating material, but the embodiments of the present disclosure are not limited thereto.

A plurality of third line connection patterns LCP3 may be disposed on the first insulating layer 1515a. The plurality of third line connection patterns LCP3 may be electrically connected to the plurality of second line connection patterns LCP2.

A second insulating layer 1515b may be disposed on a plurality of third line connection patterns LCP3. The second insulating layer 1515b may be disposed in the display area DA, the first non-display area NDA1, and the second non-display area NDA2, and may not be disposed in the entirety or part of the bending area BA, but the embodiments of the present disclosure are not limited thereto.

A plurality of fourth line connection patterns LCP4 may be arranged on the second insulating layer 1515b. The plurality of fourth line connection patterns LCP4 may be electrically connected to a plurality of third line connection patterns LCP3.

Referring to FIG. 10, according to the embodiments of the present disclosure, in the non-display area NDA, a plurality of pad connection patterns PCP may be arranged on the second protection layer 1513b. A plurality of pad connection patterns PCPs may be wiring for transmitting a signal transmitted from a flexible printed circuit 102 to a pad section 211 to a driver DRV of a display area DA.

The plurality of first pad connection patterns PCP1 may be arranged on the second protection layer 1513b. Each of the plurality of first pad connection patterns PCP1 may be arranged across the second non-display area NDA2, the bending area BA, and the first non-display area NDA1. Each of the plurality of first pad connection patterns PCP1 may include a first portion arranged in the bending area BA, a second portion extending from the first portion to the first non-display area NDA1, and a third portion extending from the first portion to the second non-display area NDA2. Each of the plurality of first pad connection patterns PCP1 may extend from the first non-display area NDA1 to a portion of the display area DA. The plurality of first pad connection patterns PCP1 may transmit a signal transmitted from the flexible printed circuit 102 to the pad portion 211 to the driver DRV of the display area DA.

Each of the plurality of first pad connection patterns PCP1 may be electrically connected to the pad PD of the pad section 211 through connection patterns arranged in the second non-display area NDA2. Here, the connection patterns electrically connecting each of the plurality of first pad connection patterns PCP1 to the pad PD may include at least one of the second pad connection pattern PCP2, the third pad connection pattern PCP3, and the fourth pad connection pattern PCP4 arranged in the second non-display area NDA2.

Each of the plurality of first pad connection patterns PCP1 may be electrically connected to the driver DRV through connection patterns arranged in the display area DA. Here, the connection patterns electrically connecting each of the plurality of first pad connection patterns PCP1 to the driver DRV may include at least one of the second pad connection pattern PCP2, the third pad connection pattern PCP3, and the fourth pad connection pattern PCP4 arranged in the display area DA.

The plurality of second pad connection patterns PCP2 may be arranged on the third protection layer 1514. The plurality of second pad connection patterns PCP2 may be arranged in the second non-display area NDA2. The second pad connection pattern PCP2 may be electrically connected to the first pad connection pattern PCP1 through a contact hole of the third protection layer 1514. Therefore, the signal supplied from the flexible printed circuit 102 can be transmitted to the first pad connection pattern PCP1 through the second pad connection pattern PCP.

The third pad connection pattern PCP3 may be arranged on the first insulating layer 1515a. The third pad connection pattern PCP3 may be arranged in the second non-display area NDA2. The third pad connection pattern PCP3 may be electrically connected to the second pad connection pattern PCP2 through a contact hole of the first insulating layer 1515a. Therefore, the signal supplied from the flexible printed circuit 102 can be transmitted to the second pad connection pattern PCP2 through the third pad connection pattern PCP3, and the signal transmitted to the second pad connection pattern PCP2 can be transmitted again to the first pad connection pattern PCP1.

The fourth pad connection pattern PCP4 may be arranged on the second insulating layer 1515b. The fourth pad connection pattern PCP4 may be arranged in the second non-display area NDA2. The fourth pad connection pattern PCP4 may be electrically connected to the third pad connection pattern PCP3 through a contact hole of the second insulating layer 1515b. The pad PD of the pad section 211 may be electrically connected to the fourth pad connection pattern PCP4 through a contact hole of the third insulating layer 1515c.

A signal supplied from a flexible printed circuit 102 is input to a pad PD of a pad section 211, and a signal input to the pad PD is transmitted to a third pad connection pattern PCP3 through a fourth pad connection pattern PCP4, and a signal transmitted to the third pad connection pattern PCP3 can be transmitted again to a first pad connection pattern PCP1 through a second pad connection pattern PCP2. A signal transmitted to the first pad connection pattern PCP1 can be transmitted to a driver DRV through connection patterns arranged in a display area DA.

Referring to FIG. 10, a plurality of line connection patterns LCP and a plurality of pad connection patterns PCP may be arranged in various metal layers. The plurality of line connection patterns LCP and the plurality of pad connection patterns PCP may be formed of any one of a conductive material having excellent ductility or various conductive materials used in a display area DA.

A third insulating layer 1515c may be disposed on the plurality of line connection patterns LCP and the plurality of pad connection patterns PCP. The third insulating layer 1515c is disposed in the display area DA, the first non-display area NDA1, and the second non-display area NDA2, and may be disposed in all or part of the bending area BA, but the embodiments of the present disclosure are not limited thereto. In the bending area BA, a part of the third insulating layer 1515c may be removed. The third insulating layer 1515c may be composed of an organic insulating material, but the embodiments of the present disclosure are not limited thereto.

A plurality of banks BNK may be disposed on the third insulating layer 1515c in the display area DA. The plurality of banks BNKs may be arranged to overlap with at least a portion of each of the plurality of sub-pixels SPa, SPb and SPc. For example, the first sub-pixel SPa may include a first light emitting device EDa that emits a first color light, the second sub-pixel SPb may include a second light emitting device EDb that emits a second color light, and the third sub-pixel SPc may include a third light emitting device EDc that emits a third color light.

As an example, one light emitting device ED may be arranged on top of each of the plurality of banks BNKs. As another example, two or more light emitting devices ED may be arranged on top of each of the plurality of banks BNK. The two or more light emitting devices EDs arranged on top of each of the plurality of banks BNK may be light emitting devices of the same type.

In the display area DA, a plurality of row connection electrodes RCE may be arranged on the third insulating layer 1515c. The plurality of row connection electrodes RCE may transfer a low-potential voltage VSS output from the driver DRV to the row line RL.

In the display area DA, a plurality of column lines CL may be arranged on the third insulating layer 1515c. The plurality of column lines CL may be arranged in an area between the plurality of banks BNK. For example, the plurality of column lines CL may be arranged adjacent to one of the plurality of banks BNK.

Each of the plurality of column lines CL may include a wiring portion and a column connection electrode CCE protruding from the wiring portion. The wiring portion and the column connection electrode CCE included in each of the plurality of column lines CL may be formed integrally or may be different metals that are electrically connected.

For example, each of the plurality of column lines CL may include a column connection electrode CCE that is a portion protruding above an adjacent bank BNK among the plurality of banks BNK. The column connection electrode CCE of each of the plurality of column lines CL may be arranged to extend along the side and upper surface of the bank BNK. The column connection electrode CCE may be an electrode electrically connected to each of the plurality of column lines CL or may be a portion protruding from each of the plurality of column lines CL.

Referring to FIG. 11, the column connection electrode CCE of the column line CL may be composed of one conductive layer or multiple conductive layers. For example, a column connection electrode CCE electrically connected to a column line CL or protruding from the column line CL may include a first conductive layer 1601, a second conductive layer 1602, a third conductive layer 1603, and a fourth conductive layer 1604, but the embodiments of the present disclosure are not limited thereto.

The first conductive layer 1601 may be disposed on a bank BNK. The second conductive layer 1602 may be disposed on the first conductive layer 1601. The third conductive layer 1603 may be disposed on the second conductive layer 1602, and the fourth conductive layer 1604 may be disposed on the third conductive layer 1603.

According to the embodiments of the present disclosure, among the plurality of conductive layers constituting the column connection electrode CCE, some conductive layers having good reflection efficiency may be configured as an alignment key and/or a reflector for aligning the light emitting devices ED. For example, among the plurality of conductive layers constituting the column connection electrode CCE, the second conductive layer 1602 may include a reflective material. For example, the second conductive layer 1602 may include aluminum (Al), but the embodiments of the present disclosure are not limited thereto. Accordingly, the second conductive layer 1602 may be configured as a reflector. In addition, due to the high reflection efficiency of the second conductive layer 1602, it can be easily identified in the manufacturing process, and thus the position or transfer position of the light emitting device ED can be aligned based on the second conductive layer 1602.

For example, in order to configure the second conductive layer 1602 as a reflector, the third conductive layer 1603 and the fourth conductive layer 1604 disposed on the second conductive layer 1602 may be partially removed or etched. For example, a portion of the third conductive layer 1603 and the fourth conductive layer 1604 disposed on the bank BNK may be removed or etched to expose the upper surface of the second conductive layer 1602. That is, the openings of the third conductive layer 1603 and the fourth conductive layer 1604 may overlap with a portion of the upper surface of the second conductive layer 1602. For example, in the third conductive layer 1603 and the fourth conductive layer 1604, the central portion and the edge portion where a solder pattern SDP is arranged may remain, and the remaining portions excluding this portion (e.g., the central portion, the edge portion) may be removed.

According to the embodiments of the present disclosure, the first conductive layer 1601 and the third conductive layer 1603 may include titanium (Ti) or molybdenum (Mo). The second conductive layer 1602 may include aluminum (Al). The fourth conductive layer 1604 may include a transparent conductive oxide layer such as indium tin oxide (ITO) or indium zinc oxide (IZO) that has good adhesion to the solder pattern SDP and corrosion resistance and acid resistance. However, the embodiments of the present disclosure are not limited thereto.

The first conductive layer 1601, the second conductive layer 1602, the third conductive layer 1603, and the fourth conductive layer 1604 may be sequentially deposited and then patterned by performing a photolithography process and an etching process, but the embodiments of the present disclosure are not limited thereto.

According to embodiments of the present disclosure, two or more of the column connection electrode CCE, the column line CL, the row connection electrode RCE, and the pad PD may be arranged on the same layer. The column connection electrode CCE, the column line CL, the row connection electrode RCE, and the pad PD may be composed of a single layer or multiple layers of a conductive material, but the embodiments of the present disclosure are not limited thereto.

According to embodiments of the present disclosure, a solder pattern SDP may be arranged on the column connection electrode CCE in each of a plurality of sub-pixels. The solder pattern SDP may bond the light emitting device ED to the column connection electrode CCE.

According to the embodiments of the present disclosure, the passivation layer 1516 may be disposed on a plurality of column lines CL, a plurality of column connection electrodes CCE, a plurality of row connection electrodes RCE, and a third insulating layer 1515c.

For example, the passivation layer 1516 may be disposed on a display area DA, a first non-display area NDA1, and a second non-display area NDA2. In the entirety or a portion of the bending area BA, at least a portion of the passivation layer 1516 covering the plurality of pads PD may be removed. A portion of the passivation layer 1516 covering the plurality of pads PD in the second non-display area NDA2 may be removed. In addition, as illustrated in FIG. 11, the passivation layer 1516 may be removed from the area where the solder pattern SDP is arranged.

Since the passivation layer 1516 is arranged to cover the remaining area except for the bending area BA, the plurality of pads PD, and the area where the solder pattern SDP is arranged, the penetration of moisture or impurities into the light emitting device ED can be reduced.

Referring to FIG. 11, the light emitting device ED may include a first electrode Ecl, a first semiconductor layer 1611, an active layer 1612, a second semiconductor layer 1613, a second electrode Erl, and an encapsulation film 1614, but the embodiments of the present disclosure are not limited thereto. For example, the encapsulation film 1614 may not be included in the light emitting device ED.

The first semiconductor layer 1611 may be disposed on the solder pattern SDP. The second semiconductor layer 1613 may be disposed on the first semiconductor layer 1611.

For example, one of the first semiconductor layer 1611 and the second semiconductor layer 1613 may be implemented as a compound semiconductor of group III-V, group II-VI, and may be doped with an impurity (or dopant). For example, one of the first semiconductor layer 1611 and the second semiconductor layer 1613 may be a semiconductor layer doped with an n-type impurity, and the other may be a semiconductor layer doped with a p-type impurity, but the embodiments of the present disclosure are not limited thereto.

For example, the first semiconductor layer 1611 and the second semiconductor layer 1613 may be a nitride semiconductor including an n-type impurity and a nitride semiconductor including a p-type impurity, respectively, but the embodiments of the present disclosure are not limited thereto. For example, the first semiconductor layer 1611 may be a nitride semiconductor containing a p-type impurity, and the second semiconductor layer 1613 may be a nitride semiconductor containing an n-type impurity, but the embodiments of the present disclosure are not limited thereto.

The active layer 1612 may be arranged between the first semiconductor layer 1611 and the second semiconductor layer 1613. The active layer 1612 may receive holes and electrons from the first semiconductor layer 1611 and the second semiconductor layer 1613 to emit light. For example, the active layer 1612 may be configured as one of a single well structure, a multi-well structure, a single quantum well structure, a multi-quantum well (MQW) structure, a quantum dot structure, and a quantum wire structure, but the embodiments of the present disclosure are not limited thereto. For example, the active layer 1612 may be configured as indium gallium nitride (InGaN) or gallium nitride (GaN), but the embodiments of the present disclosure are not limited thereto.

For another example, the active layer 1612 may include a multi-quantum well (MQW) structure having a well layer and a barrier layer having a higher band gap than the well layer. For example, the active layer 1612 may be formed of InGaN as a well layer and an AlGaN layer as a barrier layer, but the embodiments of the present disclosure are not limited thereto.

The first electrode Ecl of the light emitting device ED may be arranged between the first semiconductor layer 1611 and the solder pattern SDP. For example, the first electrode Ecl of the light emitting device ED may electrically connect the first semiconductor layer 1611 and the column connection electrode CCE. The column line voltage (e.g., the anode voltage) output from the driver DRV may be applied to the first semiconductor layer 1611 through the column line CL, the column connection electrode CCE, and the first electrode Ecl. For example, the first electrode Ecl may be composed of a conductive material capable of eutectic bonding with the solder pattern SDP, but the embodiments of the present disclosure are not limited thereto.

The second electrode Erl of the light emitting device ED may be disposed on the second semiconductor layer 1613. For example, the second electrode Erl of the light emitting device ED may electrically connect the second semiconductor layer 1613 and the row line RL. A row line voltage (e.g., referred to as a low-potential voltage VSS as a cathode voltage) output from the driver DRV may be applied to the second semiconductor layer 1613 through the row connection electrode RCE, the row line RL, and the second electrode Erl. The second electrode Erl of the light emitting device ED may be made of a transparent conductive material so that light emitted from the light emitting device ED can be directed to the upper portion of the light emitting device ED, but the embodiments of the present disclosure are not limited thereto. For example, the second electrode Erl may be made of a material such as indium tin oxide (ITO), indium zinc oxide (IZO), or indium gallium zinc oxide (IGZO), but the embodiments of the present disclosure are not limited thereto.

The encapsulation film 1614 may be disposed on at least a portion of the first semiconductor layer 1611, the active layer 1612, the second semiconductor layer 1613, the first electrode Ecl, and the second electrode Erl. For example, the encapsulation film 1614 may surround at least a portion of the first semiconductor layer 1611, the active layer 1612, the second semiconductor layer 1613, the first electrode Ecl, and the second electrode Erl.

For example, the encapsulation film 1614 may protect the first semiconductor layer 1611, the active layer 1612, and the second semiconductor layer 1613. For example, the encapsulation film 1614 may be disposed on a side surface of the first semiconductor layer 1611, a side surface of the active layer 1612, and a side surface of the second semiconductor layer 1613.

For example, the encapsulation film 1614 may be disposed on at least a portion of the first electrode Ecl and the second electrode Erl of the light emitting device ED. For example, the encapsulation film 1614 may be disposed on an edge portion (or one side) of the first electrode Ecl of the light emitting device ED and an edge portion (or one side) of the second electrode Erl of the light emitting device ED. At least a portion of the first electrode Ecl may be exposed from the encapsulation film 1614 so that the first electrode Ecl may be connected to the solder pattern SDP. For example, at least a portion of the second electrode Erl may be exposed from the encapsulation film 1614 so that the second electrode Erl may be connected to the row line RL. For example, the encapsulation film 1614 may be made of an insulating material such as silicon nitride (SiNₓ) or silicon oxide (SiOₓ), but the embodiments of the present disclosure are not limited thereto.

For another example, the encapsulation film 1614 may have a structure in which a reflective material is dispersed in a resin layer, but the embodiments of the present disclosure are not limited thereto. For example, the encapsulation film 1614 may be manufactured as a reflector of various structures, but the embodiments of the present disclosure are not limited thereto. Light emitted from the active layer 1612 may be reflected upward by the encapsulation film 1614, thereby improving light extraction efficiency. For example, the encapsulation film 1614 may be a reflective layer, but the embodiments of the present disclosure are not limited thereto.

According to the embodiments of the present disclosure, the light emitting device ED is described as having a vertical structure, but the embodiments of the present disclosure are not limited thereto. For example, the light emitting device ED may have a lateral structure or a flip chip structure.

The structure of the light emitting device ED illustrated in FIG. 11 may be substantially equally applied to all of the first light emitting device EDa, the second light emitting device EDb, and the third light emitting device EDc. According to embodiments of the present disclosure, a first optical layer 1517a may be arranged to surround a plurality of light emitting devices ED in the display area DA. For example, the first optical layer 1517a may be arranged to cover a plurality of light emitting devices ED and the bank BNK in the area of a plurality of sub-pixels SP. For example, the first optical layer 1517a may cover a bank BNK, a portion of the passivation layer 1516, and a region between the plurality of light emitting devices ED. The first optical layer 1517a may be arranged or covered between a plurality of light emitting devices ED included in one pixel and between a plurality of banks BNK. For example, the first optical layer 1517a may be arranged to extend in the first direction (X) and be spaced apart from each other in the second direction (Y). For example, the first optical layer 1517a may be arranged to surround the side of the light emitting devices ED and the banks BNK between the passivation layer 1516 and the row line RL, but the embodiments of the present disclosure are not limited thereto. For example, the first optical layer 1517a may be a diffusion layer or a sidewall diffusion layer, but the embodiments of the present disclosure are not limited thereto.

The first optical layer 1517a may include an organic insulating material having fine particles dispersed therein, but the embodiments of the present disclosure are not limited thereto. For example, the first optical layer 1517a may be composed of siloxane having fine metal particles, such as titanium dioxide (TiO₂) particles, dispersed therein, but the embodiments of the present disclosure are not limited thereto. Light from a plurality of light emitting devices ED may be scattered by the fine particles dispersed in the first optical layer 1517a and emitted to the outside of the display device 100. Accordingly, the first optical layer 1517a may improve the extraction efficiency of light emitted from the plurality of light emitting devices ED.

For example, the first optical layer 1517a may be arranged on each of a plurality of pixels, or may be arranged together on some pixels arranged in the same row, but the embodiments of the present disclosure are not limited thereto. For example, the first optical layer 1517a may be arranged on each of a plurality of pixels, or the plurality of pixels may share one first optical layer 1517a. For another example, each of the plurality of sub-pixels may separately include a first optical layer 1517a, but the embodiments of the present disclosure are not limited thereto.

According to the embodiments of the present disclosure, in the display area DA, a second optical layer 1517b may be arranged on the passivation layer 1516. For example, the second optical layer 1517b may be arranged to surround the first optical layer 1517a. For example, the second optical layer 1517b may be in contact with a side surface of the first optical layer 1517a. For example, the second optical layer 1517b may be arranged in an area between the plurality of pixels. However, the embodiments of the present disclosure are not limited thereto. For example, the second optical layer 1517b may be a diffusion layer, a diffusion layer window, or a window diffusion layer, but the embodiments of the present disclosure are not limited thereto.

The second optical layer 1517b may be composed of an organic insulating material, but the embodiments of the present disclosure are not limited thereto. The second optical layer 1517b may be composed of the same material as the first optical layer 1517a, but the embodiments of the present disclosure are not limited thereto. For example, the first optical layer 1517a may include fine particles, and the second optical layer 1517b may not include fine particles. For example, the second optical layer 1517b may be composed of siloxane, but the embodiments of the present disclosure are not limited thereto.

For example, the thickness of the first optical layer 1517a may be smaller than the thickness of the second optical layer 1517b, but the embodiments of the present disclosure are not limited thereto. Accordingly, when viewed from a planar view, the area where the first optical layer 1517a is disposed may include a concave portion that is sunken inwardly from the upper surface of the second optical layer 1517b.

According to the embodiments of the present disclosure, a row line RL may be disposed on the first optical layer 1517a and the second optical layer 1517b. For example, the row line RL may be electrically connected to a plurality of row connection electrodes RCE through contact holes of the second optical layer 1517b. For example, the row line RL may be disposed on a plurality of light emitting devices ED. For example, the row line RL may include a transparent conductive oxide such as indium tin oxide (ITO) or indium zinc oxide (IZO), but the embodiments of the present disclosure are not limited thereto. For example, the row line RL may be arranged to be in contact with the second electrode Erl of the light emitting device ED. For example, the row line RL may overlap with the first optical layer 1517a. For example, the row line RL may cover a plane on the outside of the first optical layer 1517a.

The row line RL may extend continuously in the first direction (X) of the substrate 210. Accordingly, the row line RL may be commonly connected to a plurality of pixels arranged in the first direction (X) of the substrate 210. For example, the row line RL may be commonly connected to a plurality of pixels.

According to the embodiments of the present disclosure, the row line RL may be continuously extended on the first optical layer 1517a, the second optical layer 1517b, and the light emitting device ED. The area where the first optical layer 1517a is disposed may include a concave portion that is sunken inwardly from the upper surface of the second optical layer 1517b. Accordingly, the first part of the row line RL disposed on the first optical layer 1517a may be disposed along the concave portion, and thus may be disposed at a lower position than the second part of the row line RL disposed on the second optical layer 1517b.

A third optical layer 1517c may be disposed on the row line RL. The third optical layer 1517c may be disposed so as to overlap with a plurality of light emitting devices ED and the first optical layer 1517a. Since the third optical layer 1517c is arranged on the row line RL and the plurality of light emitting devices ED, it is possible to improve a mura that may occur in some of the plurality of light emitting devices ED. For example, when transferring a plurality of light emitting devices ED onto the substrate 210 of the display panel 110, there may occur an area where the spacing between the plurality of light emitting devices ED is not uniform due to process deviation. If the spacing between the plurality of light emitting devices ED is not uniform, an emission areas of each of the plurality of light emitting devices ED may be arranged unevenly, and thus a mura may be visible to the user. Accordingly, since the third optical layer 1517c is arranged to uniformly diffuse light over the plurality of light emitting devices ED, it is possible to reduce light emitted from some of the light emitting devices ED from being visible as a mura. Accordingly, since the light emitted from the plurality of light emitting devices EDs is evenly diffused by the third optical layer 1517c and extracted to the outside of the display device 100, the luminance uniformity of the display device 100 can be improved.

The third optical layer 1517c may be composed of an organic insulating material in which fine particles are dispersed, but the embodiments of the present disclosure are not limited thereto. For example, the third optical layer 1517c may be composed of siloxane in which fine metal particles such as titanium dioxide (TiO₂) particles are dispersed, but the embodiments of the present disclosure are not limited thereto. For example, the third optical layer 1517c may be composed of the same material as the first optical layer 1517a, but the embodiments of the present disclosure are not limited thereto. For example, the third optical layer 1517c may be a diffusion layer or an upper diffusion layer, but the embodiments of the present disclosure are not limited thereto.

According to the embodiments of the present disclosure, light from a plurality of light emitting devices ED may be scattered by fine particles dispersed in a third optical layer 1517c and emitted to the outside of the display device 100. The third optical layer 1517c may evenly mix light emitted from a plurality of light emitting devices ED, thereby further improving the luminance uniformity of the display device 100. In addition, the light extraction efficiency of the display device 100 may be improved by the light scattered from the plurality of fine particles, thereby enabling the display device 100 to be driven at low power.

A black matrix BM may be arranged on the row line RL, the first optical layer 1517a, the second optical layer 1517b, and the third optical layer 1517c in the display area DA. For example, the black matrix BM may fill a contact hole of the second optical layer 1517b. The black matrix BM may be configured to cover the display area DA, so that the color mixing of light and external light reflection of the plurality of sub-pixels can be reduced. For example, the black matrix BM may also be arranged in the contact hole where the row line RL and the row connection electrode RCE are connected, so that light leakage between the neighboring plurality of sub-pixels can be prevented.

A cover layer 1518 may be arranged on the black matrix BM in the display area DA. The cover layer 1518 may protect a configuration under the cover layer 1518. For example, the cover layer 1518 may be composed of an organic insulating material, but the embodiments of the present disclosure are not limited thereto.

A polarizing layer 114 may be arranged on the cover layer 1518 via a first adhesive layer 112. A cover member 118 may be arranged on the polarizing layer 114 via a second adhesive layer 116.

According to embodiments of the present disclosure, a plurality of pads PD may be arranged on a third insulating layer 1515c in a second non-display area NDA2. For example, at least a portion of the plurality of pads PD may be exposed from a passivation layer 1516. For example, the plurality of pads PD may be electrically connected to a fourth pad connection pattern PCP4 through a contact hole of the third insulating layer 1515c.

An adhesive layer ACF may be arranged on the plurality of pads PD. The adhesive layer ACF may be an adhesive layer in which conductive balls are dispersed in an insulating material, but embodiments of the present disclosure are not limited thereto. When heat or pressure is applied to the adhesive layer ACF, the conductive balls may be electrically connected at a portion where the heat or pressure is applied, thereby having conductive properties. The adhesive layer ACF may be disposed between a plurality of pads PD and a flexible printed circuit 102, so that the flexible printed circuit 102 may be attached or bonded to the plurality of pads PD. For example, the adhesive layer ACF may be an anisotropic conductive film ACF, but the embodiments of the present disclosure are not limited thereto.

A flexible printed circuit 102 may be disposed on the adhesive layer ACF. The flexible printed circuit 102 may be electrically connected to the plurality of pads PD through the adhesive layer ACF. Accordingly, a signal supplied from the flexible printed circuit 102 may be transmitted to a driver DRV of a display area DA through the plurality of pads PD, the fourth pad connection pattern PCP4, the third pad connection pattern PCP3, the second pad connection pattern PCP2, and the first pad connection pattern PCP1.

Referring to FIG. 10, the display panel 110 according to the embodiments of the present disclosure may include a substrate 210, a layer stack 1410 on a plurality of drivers DRV disposed on the substrate 210, an optical layer 1517a disposed between a plurality of light emitting devices EDa, EDb and EDc on the layer stack 1410, an adhesive layer 116 disposed on the plurality of light emitting devices EDa, EDb and EDc and the optical layer 1517a, and a cover member 118 disposed on the adhesive layer 116.

Referring to FIG. 10, a plurality of column lines CL may be disposed between the layer stack 1410 and the plurality of light emitting devices EDa, EDb and EDc.

Referring to FIG. 10, a plurality of row lines RL may be arranged on a plurality of light emitting devices EDa, EDb and EDc and an optical layer 1517a. A plurality of row lines RL may be arranged between a plurality of light emitting devices EDa, EDb and EDc, an optical layer 1517a, and an adhesive layer 116.

Referring to FIG. 10, a layer stack 1410 may include a plurality of protection layers 1513a, 1513b and 1514 arranged on the side and upper surface of each of a plurality of drivers DRV, a plurality of insulating layers 1515a, 1515b and 1515c arranged on the plurality of protection layers 1513a, 1513b and 1514, and a bank BN arranged on the plurality of insulating layers.

The plurality of protection layers 1513a, 1513b and 1514 may further include a side protection layer 1513 disposed on each side of the plurality of drivers DRV and an upper protection layer 1514 disposed on the upper surface of each of the plurality of drivers DR.

The side protection layer 1513 may include a first protection layer 1513a disposed on the substrate 210 and a second protection layer 1513b disposed on the first protection layer 1513a.

The upper protection layer 1514 may include a second protection layer 1513b and a third protection layer 1514 disposed on the plurality of drivers DRV.

The plurality of insulating layers 1515a, 1515b and 1515c may include a first insulating layer 1515a disposed on the upper protection layer 1514, and a second insulating layer 1515b disposed on the first insulating layer 1515a. The plurality of insulating layers 1515a, 1515b and 1515c may further include a third insulating layer 1515c disposed on the second insulating layer 1515b.

Each of the plurality of light emitting devices EDa, EDb and EDc may be disposed on the bank BNK and positioned in an opening of the optical layer 1517a.

At least a portion of each of the plurality of column lines CL may extend onto the bank BNK on the plurality of insulating layers 1515a, 1515b and 1515c. Each of the plurality of row lines RL may be arranged on the optical layer 1517a and the plurality of light emitting devices EDa, EDb and EDc.

A first electrode Ecl of each of the plurality of light emitting devices EDa, EDb and EDc may be electrically connected to at least a portion of a column line CL extending onto the bank BNK among the plurality of column lines CL. A second electrode Erl of each of the plurality of light emitting devices EDa, EDb and EDc may be electrically connected to one of the plurality of row lines RL.

Referring to FIG. 10, the display panel 110 according to the embodiments of the present disclosure may include a plurality of line connection patterns LCPs that connect each of a plurality of lines including a plurality of row lines RL and a plurality of column lines CL to a plurality of drivers DR.

The plurality of line connection patterns LCPs may include a first line connection pattern LCP1 disposed on a side protection layer 1513, a second line connection pattern LCP2 disposed on an upper protection layer 1514 and electrically connected to the first line connection pattern LCP1 through a hole in the upper protection layer 1514, a third line connection pattern LCP3 disposed on a first insulating layer 1515a and electrically connected to the second line connection pattern LCP2 through a hole in the first insulating layer 1515a, and a fourth line connection pattern LCP4 disposed on a second insulating layer 1515b and electrically connected to the third line connection pattern LCP3 through a hole in the second insulating layer 1515b.

The first line connection pattern LCP1 may be electrically connected to one of the plurality of drivers DRV. The fourth line connection pattern LCP4 may be electrically connected to at least one second electrode Erl of the plurality of light emitting devices EDa, EDb and EDc, or may be electrically connected to at least one first electrode Ecl of the plurality of light emitting devices EDa, EDb and EDc.

The side protection layer 1513 arranged on each side of the plurality of drivers DRV may include two or more organic layers.

The first and second protection layers 1513a and 1513b as the side protection layer 1513, the third protection layer 1514 as the upper protection layer 1514, and the first to third insulating layers 1515a, 1515b and 1515c may each be composed of organic layers.

In the above, there have been described the structure and operation related to the display function of the display device 100 according to the embodiments of the present disclosure.

The display device 100 according to the embodiments of the present disclosure may provide not only a display function but also a touch sensing function. Accordingly, hereinafter, it will be described a structure and an operation related to the touch sensing function of the display device 100 according to the embodiments of the present disclosure.

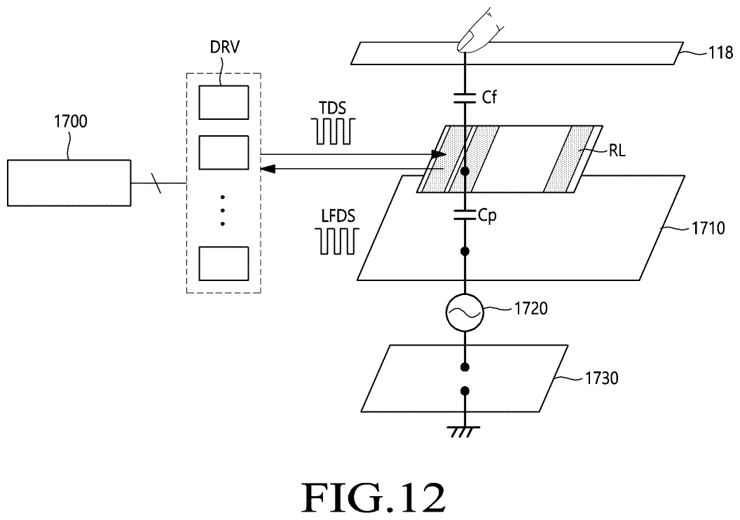

FIG. 12 briefly illustrates a touch sensing structure of a display device according to embodiments of the present disclosure.

Referring to FIG. 12, the display device 100 according to the embodiments of the present disclosure may include a plurality of row lines RL that serve as touch sensors to perform touch sensing, a plurality of drivers DRV for driving and sensing the plurality of row lines RL, and a touch control circuit 1700 that controls the plurality of drivers DRV.

The plurality of drivers DRV may supply a touch driving signal TDS having a variable voltage level to at least one of the plurality of row lines RL.

The touch driving signal TDS is a signal whose voltage level fluctuates, and may also be referred to as an AC signal or a pulse signal.

A plurality of drivers DRV may sense or detect an electrical state (e.g., a capacitance change) in at least one of a plurality of row lines RL to generate sensing data, and output the generated sensing data. Here, the sensing data may include digital sensing values.

The plurality of drivers DRV may include at least one analog-to-digital converter ADC to sense an electrical state in at least one of the plurality of row lines RL to obtain digital sensing values.

For example, the electrical state in at least one of the plurality of row lines RL may include a capacitance Cf between a touch object such as a finger or a pen and each row line RL. For another example, the electrical state in at least one of the plurality of row lines RL may include a capacitance between two row lines RL.

The touch control circuit 1700 may supply a touch driving signal TDS or a signal as a base of the touch driving signal TDS to each of the plurality of drivers DRV, and determine an occurrence of a touch or a touch position based on sensing data provided from each of the plurality of drivers RV.

If a touch driving signal TDS is applied to at least one of a plurality of row lines RL for touch sensing, an unwanted parasitic capacitance Cp may be formed between the row line RL supplied with the touch driving signal TDS and other electrodes or other wirings around the corresponding row line RL. The parasitic capacitance Cp may be a factor causing a reduction of the touch sensitivity.

The display device 100 according to the embodiments of the present disclosure may further include a touch ground 1710 arranged below the plurality of row lines RL. The touch ground 1710 may correspond to an electrode that forms a parasitic capacitance Cp with the row line RL.

The display device 100 according to the embodiments of the present disclosure may further include a guard driver 1720 that supplies a load-free driving signal LFDS whose signal characteristics correspond to the touch driving signal TDS to the touch ground 1710 in order to prevent an unwanted parasitic capacitance Cp from being formed between the row line RL and the touch ground 1710.

The load-free driving signal LFDS output from the guard driver 1720 applied to the touch ground 1710 may be a signal whose signal characteristics are similar to the touch driving signal TDS output from the driver DRV and supplied to the row line RL. For example, the signal characteristics may include frequency, amplitude, and phase. For example, the load-free driving signal LFDS may have the same frequency as the touch driving signal TDS. The load-free driving signal LFDS may have the same amplitude as the touch driving signal TDS. The load-free driving signal LFDS may have the same phase as the touch driving signal TDS.

The display device 100 according to the embodiments of the present disclosure may further include a system ground 1730 that serves as a ground for the entire system.

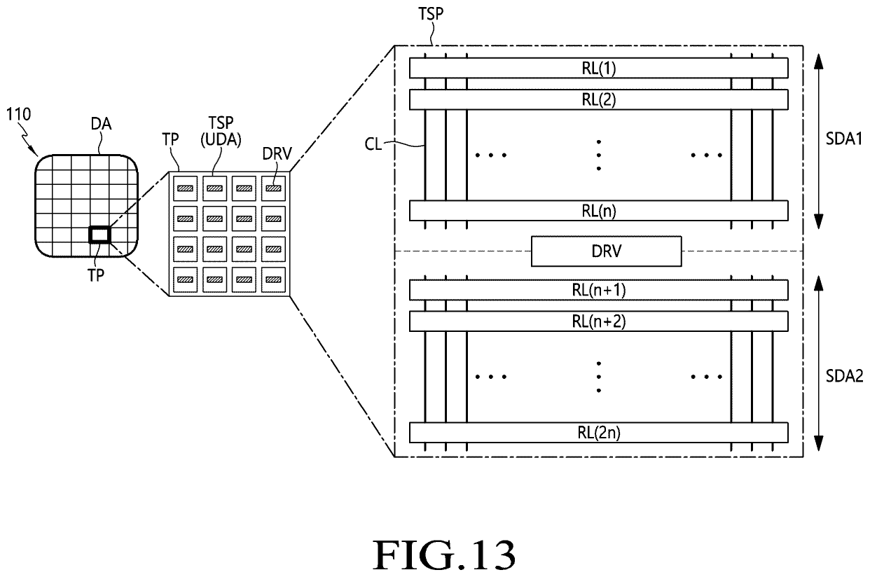

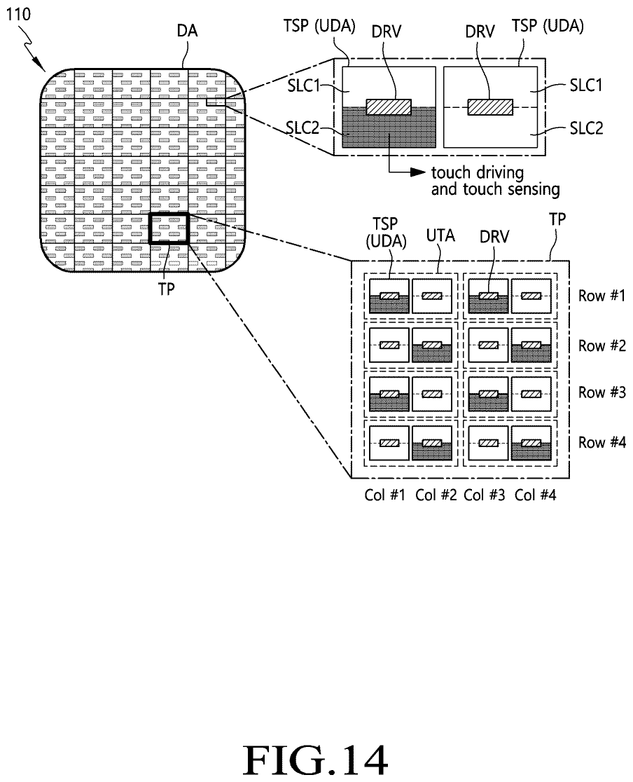

FIGS. 13 and 14 illustrate a touch driving structure of a display panel 110 according to embodiments of the present disclosure. FIGS. 1 to 12 are also referred to in the following description.

Referring to FIGS. 13 and 14, the display area DA of the display panel 110 may include a plurality of touch pixel areas TP. Each of the plurality of touch pixel areas TP may be an area corresponding to one touch electrode TE.

Each of the plurality of touch pixel areas TP may include a plurality of touch sub-pixel areas TSP. According to the examples of FIGS. 13 and 14, each of the plurality of touch pixel areas TP may include 16 touch sub-pixel areas TSP. The 16 touch sub-pixel areas TSP may be arranged in four rows and four columns.

Each of the plurality of touch sub-pixel areas TSP may include one of the plurality of drivers DRV. That is, one driver DRV may be disposed in one touch sub-pixel area TSP. One touch sub-pixel area TSP may correspond to one unit driving area UDA.

Each of the plurality of touch sub-pixel areas TSP may include a plurality of row lines RL(1) to RL(2n), (where n is a natural number greater than or equal to 1) and a plurality of column lines CL. Each of the plurality of touch sub-pixel areas TSP may include a plurality of sub-pixels SP. Each of the plurality of touch sub-pixel areas TSP may include a plurality of light emitting devices ED.

Each of the plurality of touch sub-pixel areas TSP may include a first sub-driving area SDA1 and a second sub-driving area SDA2. The first sub-driving area SDA1 may include two or more row lines RL(1) to RL(n) and two or more column lines CL. The second sub-driving area SDA2 may include two or more row lines RL(n+1) to RL(2n) and two or more column lines CL.

A plurality of row lines RL arranged in one touch pixel area TP corresponding to one touch electrode and simultaneously performing touch driving may be processed as one touch electrode TE in the touch control circuit 1700 even if they are driven and sensed by a plurality of drivers DRV. That is, a plurality of row lines RL arranged in one touch pixel area TP and simultaneously performing touch driving may be recognized as one touch electrode TE electrically connected to each other.

The touch control circuit 1700 may determine an occurrence of the touch and/or a touch coordinate by considering the integrated sensing data SEN_DATA obtained from each of the plurality of row lines RL arranged in one touch pixel area TP and simultaneously performing touch driving as sensing data obtained from one touch electrode TE.

Referring to FIG. 14, each of the plurality of touch pixel areas TP may include two or more unit touch driving areas UTA. Each of the two or more unit touch driving areas UTA may include at least one touch sub-pixel area TSP. According to the example of FIG. 14, each of the two or more unit touch driving areas UTA may include two touch sub-pixel areas TSP. Here, the unit touch driving area UTA is an area that becomes a basic unit of a touch driving pattern.

One touch sub-pixel area TSP corresponding to one unit driving area UDA may include two sub-touch driving areas SLC1 and SLC2. The two sub-touch driving areas may include a first sub-touch driving area SLC1 and a second sub-touch driving area SLC2. For example, the first sub-touch driving area SLC1 may correspond to an upper area in one touch sub-pixel area TSP, and the second sub-touch driving area SLC2 may correspond to a lower area in one touch sub-pixel area TSP. However, embodiments of the present disclosure are not limited thereto.

Two or more row lines RL and two or more column lines CL may be arranged in each of the first sub-touch driving area SLC1 and the second sub-touch driving area SLC2. Each of the first sub-touch driving area SLC1 and the second sub-touch driving area SLC2 may include two or more light emitting devices ED.

Two or more row lines RL arranged in the first sub-touch driving area SLC1 and two or more row lines RL arranged in the second sub-touch driving area SLC2 may not be connected to each other, and may be arranged separately from each other. Two or more column lines CL arranged in the first sub-touch driving area SLC1 and two or more column lines CL arranged in the second sub-touch driving area SLC2 may not be connected to each other, and may be arranged separately from each other.

The two sub-touch driving areas SLC1 and SLC2 may correspond to the two sub-driving areas SDA1 and SDA2 included in one unit driving area UDA in FIG. 4, FIG. 5, and FIG. 8, respectively.

One unit touch driving area UTA may include two touch sub-pixel areas TSP. One unit touch driving area UTA may include two sub-touch driving areas SLC1 and SLC2 included in each of two touch sub-pixel areas TSP. That is, one unit touch driving area UTA may include four sub-touch driving areas. One unit touch driving area UTA may include two drivers DRV.

For example, a touch pixel area TP may include 16 touch sub-pixel areas TSP arranged in four rows and four columns. Each of the 16 touch sub-pixel areas TSP may include one driver DRV and two sub-touch driving areas SLC1 and SLC2.

As an example, during a touch driving period for touch sensing, all four sub-touch driving areas included in one unit touch driving area UTA may be driven and sensed. Accordingly, during a touch driving period for touch sensing, each of the two drivers DRV included in one unit touch driving area UTA may drive and sense all two sub-touch driving areas SLC1 and SLC2 included in the corresponding touch sub-pixel area TSP.

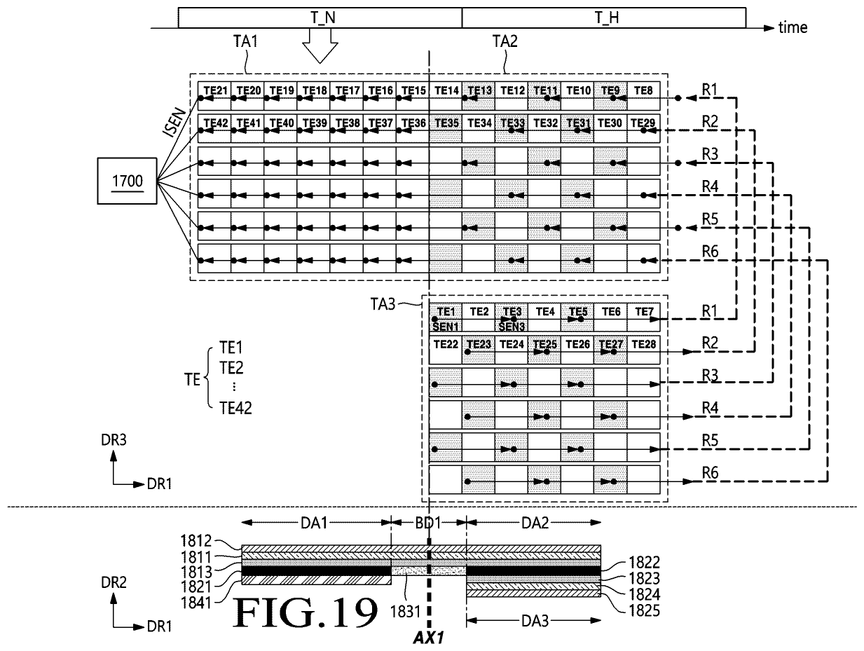

As another example, during a touch driving period for touch sensing, only some of the four sub-touch driving areas included in one unit touch driving area UTA may be driven and sensed. According to the example of FIG. 19, during the touch driving period for touch sensing, only one sub-touch driving area among four sub-touch driving areas included in one unit touch driving area UTA may be driven and sensed. Accordingly, during the touch driving period for touch sensing, only one driver DRV among two drivers DRV included in one unit touch driving area UTA may drive and sense one of two sub-touch driving areas SLC1 and SLC2 included in the corresponding touch sub-pixel area TSP.

According to the embodiments of the present disclosure, the fact that the sub-touch driving area is driven and sensed may mean that two or more row lines RL arranged in the sub-touch driving area are driven (i.e., touch driven) and sensed.

The fact that two or more row lines RL arranged in the sub-touch driving area are driven (i.e., touch driven) may mean that a touch driving signal TDS having a variable voltage level is applied to two or more row lines RL arranged in the sub-touch driving area.

Referring to FIG. 14, in the touch pixel area TP, the sub-touch driving area where touch driving and touch sensing are performed may be arranged in a zigzag shape.

For example, if a touch pixel area TP includes 16 touch sub-pixel areas TSP arranged in four rows and four columns, in each of the first touch sub-pixel row Row #1 and the third touch sub-pixel row Row #3, the second sub-touch driving area SLC2 among the two sub-touch driving areas SLC1 and SLC2 included in the touch sub-pixel area TSP located in the first column Col #1 may be driven and sensed, the two sub-touch driving areas SLC1 and SLC2 included in the touch sub-pixel area TSP located in the second column Col #2 may be not driven and sensed. In addition, the second sub-touch driving area SLC2 among the two sub-touch driving areas SLC1 and SLC2 included in the touch sub-pixel area TSP located in the third column Col #3 may be driven and sensed, and the two sub-touch driving areas SLC1 and SLC2 included in the touch sub-pixel area TSP located in the fourth column Col #4 may not be driven and sensed.

In the second touch sub-pixel row Row #2 and the fourth touch sub-pixel row Row #4, the two sub-touch driving areas SLC1 and SLC2 included in the touch sub-pixel area TSP located in the first column Col #1 may not be driven and sensed, and the second sub-touch driving area SLC2 among the two sub-touch driving areas SLC1 and SLC2 included in the touch sub-pixel area TSP located in the second column Col #2 may be driven and sensed. In addition, the two sub-touch driving areas SLC1 and SLC2 included in the touch sub-pixel area TSP located in the third column Col #3 may not be driven and sensed, and the second sub-touch driving area SLC2 among the two sub-touch driving areas SLC1 and SLC2 included in the touch sub-pixel area TSP located in the fourth column Col #4 may be driven and sensed.

Referring to FIG. 14, one touch pixel area TP includes a plurality of touch sub-pixel areas TSP, and each of the plurality of touch sub-pixel areas TSP may include two or more row lines RL and two or more column lines CL. Each of the plurality of touch sub-pixel areas TSP may include two or more light emitting devices ED.

Referring to FIG. 14, one touch pixel area TP includes a plurality of touch sub-pixel areas TSP, and each of the plurality of touch sub-pixel areas TSP may include two sub-touch driving areas SLC1 and SLC2. Each of the two sub-touch driving areas SLC1 and SLC2 may include two or more row lines RL and two or more column lines CL. Each of the two sub-touch driving areas SLC1 and SLC2 may include two or more light emitting devices ED.

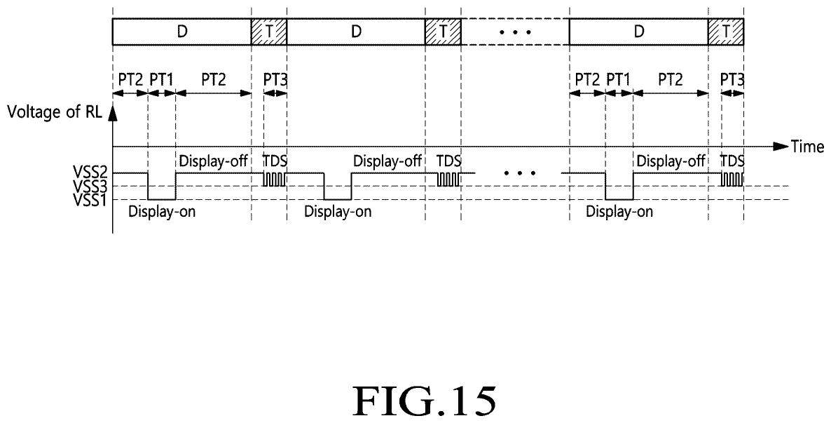

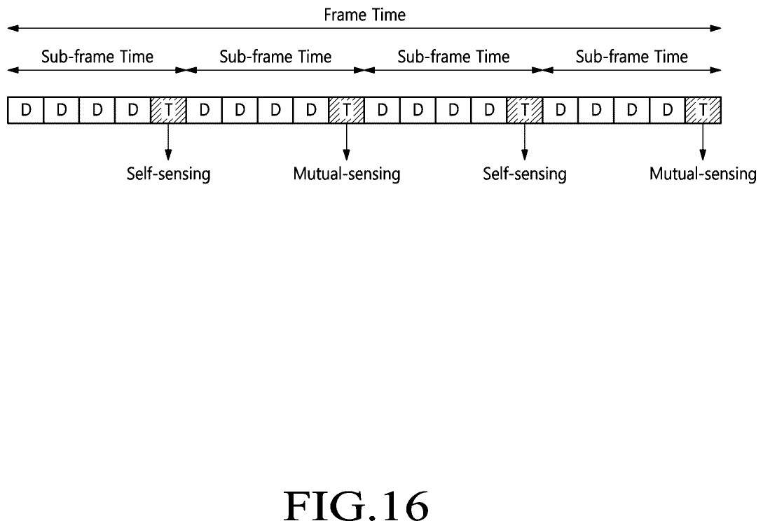

FIG. 15 and FIG. 16 are driving timing diagrams of a display device 100 according to embodiments of the present disclosure.

Referring to FIG. 15 and FIG. 16, the display device 100 according to the embodiments of the present disclosure may perform display driving for image display and touch driving (or touch sensing) for touch sensing. The display device 100 according to the embodiments of the present disclosure may allocate a display driving period D and a touch driving period T, perform display driving during the display driving period D, and perform touch driving during the touch driving period T.

The display device 100 according to the embodiments of the present disclosure may perform display driving and touch driving according to a time-division driving method or a simultaneous driving method.

For example, the display device 100 according to the embodiments of the present disclosure may allocate the display driving period D and the touch driving period T as separate time periods according to the time-division driving method, and may perform display driving during the display driving period D and perform touch driving during the touch driving period T different from the display driving period D.

As another example, the display device 100 according to the embodiments of the present disclosure may perform display driving and touch driving simultaneously during the display driving period D and the touch driving period T that overlap in time according to the simultaneous driving method.

Hereinafter, for the convenience of explanation, the display device 100 according to the embodiments of the present disclosure performs display driving and touch driving at different time periods according to the time division driving method as an example. However, this is not limited thereto.

As an example of a time division driving method, as illustrated in FIG. 15, one display driving period D and one touch driving period T may alternately proceed. That is, one display driving period D may proceed, and then one touch driving period T may proceed.

As an example, one display driving period D may be a period during which display driving is performed to display an image on the entire screen. That is, the period that is the sum of one display driving period D and one touch driving period T may be one frame period. In this case, one display driving period D may correspond to an active period among the active period and a blank period included in one frame period, and one touch driving period T may correspond to one blank period among the active period and blank period included in one frame period.

As another example, two or more display driving periods D may be a period during which display driving is performed to display an image on the entire screen. That is, the time period that is the sum of two or more display driving periods D and two or more touch driving periods T may be a frame period. In this case, one frame period may include two or more sub-frame period. Each of the two or more sub-frame period may include one sub-active period and one sub-blank period. The time summing one display driving period D and one touch driving period T may be one sub-frame period among two or more sub-frame periods included in one frame period. One display driving period D included in one sub-frame period may correspond to one sub-active period, and one touch driving period T may correspond to one sub-blank period.

As another example of the time division driving method, as illustrated in FIG. 16, a plurality of display driving periods D and one touch driving period T may alternately proceed. That is, a plurality of display driving periods D may proceed, and then one touch driving period T may proceed.

According to the example of FIG. 16, four display driving periods D may be performed, and then one touch driving period T may be performed. For example, the time summing four display driving periods D and one touch driving period T may correspond to one sub-frame period, and the time summing four sub-frame periods may correspond to one frame period for displaying an image on the entire screen.

According to the example of FIG. 16, four touch driving periods T included in one frame period may include self-sensing-based touch driving periods T and mutual-sensing-based touch driving periods T that are alternately proceeded. For example, among the four touch driving periods T included in one frame period, the first and third touch driving periods T may be self-sensing-based touch driving periods T, and the second and fourth touch driving periods T may be mutual-sensing-based touch driving periods T.

Referring to FIG. 15, a plurality of row lines RL may simultaneously perform the role of a cathode electrode (or an anode electrode) for display driving and the role of a touch sensor (e.g., touch electrode) for touch driving. Therefore, the electrical state of the row line RL during the display driving period D and the electrical state of the row line RL during the touch driving period T may be different.

One row line RL among the plurality of row lines RL may be supplied with a first low-potential voltage VSS1 during a first period PT1, and may be supplied with a second low-potential voltage VSS2 during a second period PT2 different from the first period PT1.

The first period PT1 and the second period PT2 may be periods included in one display driving period D or periods included in different display driving periods D.

The first low-potential voltage VSS1 and the second low-potential voltage VSS2 are a type of low-potential voltage VSS and may be a row line voltage applied to the row line RL. In addition, the first low-potential voltage VSS1 and the second low-potential voltage VSS2 may be a voltage (for example, a cathode voltage or an anode voltage) applied to the second electrode Erl of the light emitting devices ED connected to the row line RL.

Among the first low-potential voltage VSS1 and the second low-potential voltage VSS2, the first low-potential voltage VSS1 may be a low-potential voltage for driving the display-on, and the second low-potential voltage VSS2 may be a low-potential voltage for driving the display-off.

The first low-potential voltage VSS1 may be a voltage lower than the second low-potential voltage VSS2. That is, the second low-potential voltage VSS2 may be a higher voltage than the first low-potential voltage VSS1. Accordingly, during the first period PT1, the voltage difference between the first electrode Ecl and the second electrode Erl of the light emitting device ED may be higher than the threshold voltage of the light emitting device ED. Accordingly, the light emitting device ED may be in a state capable of emitting light. Then, during the second period PT2, the voltage difference between the first electrode Ecl and the second electrode Erl of the light emitting device ED may be lower than the threshold voltage of the light emitting device ED. Accordingly, the light emitting device ED may be in a state in which it cannot emit light.

Meanwhile, one of the plurality of row lines RL may be supplied with a touch driving signal TDS, which is a signal whose voltage level swings, during a third period PT3 different from the first period PT1 and the second period PT2.

The third period PT3 may be a period included in the touch driving period T. The touch driving signal TDS may be a signal having a predetermined frequency and whose voltage level fluctuates. The touch driving signal TDS may be a signal that swings between a predefined high voltage and a low voltage. For example, the high voltage may be a second low-potential voltage VSS2, and the low voltage may be a third low-potential voltage VSS3. The amplitude of the touch driving signal TDS may be a voltage difference between the high voltage and the low voltage. For example, the third low-potential voltage VSS3 may be a voltage lower than the second low-potential voltage VSS2 and may be the same as or different from the first low-potential voltage VSS1. For example, the third low-potential voltage VSS3 may be a voltage higher than the first low-potential voltage VSS1 and lower than the second low-potential voltage VSS2.

Depending on the driving type and driving timing, each of the plurality of row lines RL may be driven in a predetermined method.

For example, the display-on driving for each of the plurality of row lines RL may be performed sequentially. For another example, the display-on driving for each of the plurality of row lines RL may be performed simultaneously. For another example, the display-on driving for each of two or more row lines RL among the plurality of row lines RL may be performed simultaneously.

For example, during a specific display driving period, among the plurality of row lines RL arranged in the unit driving area UDA, display-on driving may be performed for at least one row line RL, and display-off driving may be performed for the remaining row lines RL without display-on driving.

The display-on driving performed for a specific row line RL may mean that a first low-potential voltage VSS1 of a predefined level is supplied to the corresponding row line RL.

When the display-on driving for a specific row line RL is performed, the light emitting devices ED arranged corresponding to the corresponding row line RL may emit light.

The display-off driving performed for a specific row line RL without display-on driving may mean that a second low-potential voltage VSS2 of a predefined level is supplied to the corresponding row line RL. Here, the second low-potential voltage VSS2 may be a higher voltage than the first low-potential voltage VSS1.

When display-off driving is performed for a specific row line RL, the light emitting devices ED arranged corresponding to the row line RL may not emit light.

For example, a first row line RL among the plurality of row lines RL may be supplied with a first low-potential voltage VSS1 during a first period, and may be supplied with a second low-potential voltage VSS2 higher than the first low-potential voltage VSS1 during a second period different from the first period. For example, the first period and the second period may be included in one display driving period. For another example, the first period and the second period may be included in different display driving periods.

Referring to FIG. 1, the display device 100 may be a flat shape that does not be folded or bent. The display device 100 may be a fixed shape that does not change shape. However, the display device 100 may include a plurality of display areas, and a space between the plurality of display areas may be bent. That is, the display device 100 may be a foldable display device 100. If the display device 100 is in a folded state, the number of display areas may be 1, and if the display device 100 is in an unfolded state, the number of display areas may be 2 or more. Hereinafter, a foldable display device 100 will be described.

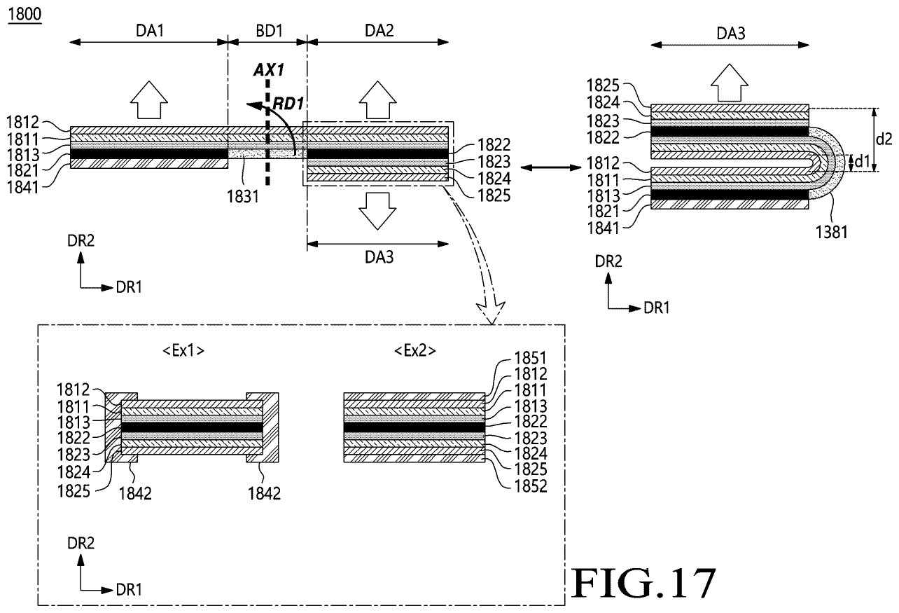

FIG. 17 is a cross-sectional view of a foldable display device 100 according to embodiments of the present disclosure.

Referring to FIG. 17 illustrates a display device 100 being folded or unfolded.

The features of the display device 100 illustrated in FIG. 17 may be the same as the features of the display device 100 illustrated in FIGS. 1 to 16. That is, the light emitting device ED, the column line CL, the row line RL, the display operation, the touch operation included in the display device 100 may be the same as the features of the display device 100 illustrated in FIGS. 1 to 16.

The display device 100 may have an in-cell touch structure in which touch sensing is performed through the row line RL. However, for convenience of explanation, FIG. 17 illustrates a case in which the display device 100 includes a first display unit 1811 and a first touch panel unit 1812, and the first touch panel unit 1812 is disposed on the first display unit 1811.

The first display unit 1811 may include a substrate 210, a light emitting device ED, a column line CL, a row line RL, a driver DRV, and the first display unit 1811 may emit light to display an image.

The first display unit 1811 may be a display panel 110 formed integrally. The first display unit 1811 may include a first display area DA1, a first bending area BD1, and a second display area DA2.

The first bending area BD1 may be positioned adjacent to the first display area DA1 in a first direction DR1. The first bending area BD1 may be a region capable of folding or bending.

The second display area DA2 may be positioned adjacent to the first bending area BD1 in the first direction DR1.

The first touch panel unit 1812 may be disposed on the first display unit 1811, and the first touch panel unit 1812 may include a plurality of touch electrodes TE. The plurality of touch electrodes TE may be configured by a plurality of row lines RL.

A first adhesive layer 1813 may be disposed under the first display unit 1811. The first adhesive layer 1813 may include a material having adhesive properties. For example, the first adhesive layer 1813 may be OCA, PSA, etc.

A first bottom plate 1821 may be disposed on the lower side of the first adhesive layer 1813. The first bottom plate 1821 may include a hard material that does not bend easily. The first bottom plate 1821 may be located in the first display area DA1. As the first bottom plate 1821 is positioned below the first display unit 1811 in the first display area DA1, the first display unit 1811 corresponding to the first display area DA1 may maintain a flat state without being bent.

A second bottom plate 1822 may be disposed under the first adhesive layer 1813. The second bottom plate 1822 may include a hard material that does not easily bend. The second bottom plate 1822 may be positioned in the second display area DA2. As the second bottom plate 1822 is positioned below the first display unit 1811 in the second display area DA2, the first display unit 1811 corresponding to the second display area DA2 may maintain a flat state without being bent.

The first hinge portion 1831 may connect the first bottom plate 1821 and the second bottom plate 1822. The first hinge portion 1831 may be bent by an external force. The first hinge portion 1831, and may be bent in a first rotation direction RD1. Referring to FIG. 17, the first rotation direction RD1 may be counterclockwise. Referring to FIG. 17, the first hinge portion 1831 may be bent in the first rotation direction RD1 with respect to a first axis AX1.

Referring to FIG. 17, a first frame 1841 may be disposed under the first bottom plate 1821. For convenience of explanation, the first frame 1841 is illustrated as being placed under the first bottom plate 1821, but the first frame 1841 may surround the outer periphery of each of the first touch panel unit 1812, the first display unit 1811, the first adhesive layer 1813, and the first bottom plate 1821, and may protect the components described above from the outside.

A second adhesive layer 1824 may be disposed under the second bottom plate 1822. For convenience of explanation, the second adhesive layer 1824 is illustrated as being arranged under the second bottom plate 1822, but the second adhesive layer 1824 may surround the outer periphery of each of the first touch panel unit 1812, the first display unit 1811, the first adhesive layer 1813, and the second bottom plate 1822, and may protect the corresponding components from the outside.

A second display unit 1824 may be disposed under the second adhesive layer. The second display unit 1824 may include a substrate 210, a light emitting device ED, a column line CL, a row line RL, a driver DRV, and the second display unit 1824 may emit light to display an image. A third display area DA3 may be an area where an image is displayed through the second display unit 1824.

A second touch panel unit 1825 may be disposed under the second display unit 1824. The features of the second touch panel unit 1825 may be the same as the features of the first touch panel unit 1812. For convenience of explanation, the second touch panel unit 1825 is illustrated as an on-cell touch panel structure, but the second touch panel unit 1825 may have an in-cell touch panel structure. That is, the second touch panel unit 1825 may include a plurality of touch electrodes TE formed by a plurality of row lines RL.

Referring to the first example <Ex1> of FIG. 17, a second frame 1842 may be disposed at the outer periphery of the first display unit 1811, the first touch panel unit 1812, the second display unit 1824, and the second touch panel unit 1825. The second frame 1842 may protect each of the first display unit 1811, the first touch panel unit 1812, the second display unit 1824, and the second touch panel unit 1825 from the outside.

Referring to the second example <Ex2> of FIG. 17, it is illustrates a first protection film 1851 and a second protection film 1852. The first protection film 1851 may be disposed on the first touch panel unit 1812. The second protection film 1852 may be disposed under the second touch panel unit 1825. The first protection film 1851 and the second protection film 1852 may include a transparent material. The first protection film 1851 and the second protection film 1852 may be in the form of a thin film or a thin layer. The first protection film 1851 and the second protection film 1852 may protect the components disposed between the first protection film 1851 and the second protection film 1852 from the outside. Although not shown in FIG. 17, the first protection film 1851 and the second protection film 1852 may be arranged to surround the periphery of the first display unit 1811, the first touch panel unit 1812, the second display unit 1824, and the second touch panel unit 1825.

Referring to FIG. 17, when the display device 100 is completely folded, the display areas DA1, DA2 and DA3 of the display device 100 may overlap with each other.

If the display device 100 is in an unfolded state, an image may be displayed through the first display area DA1, the first bending area BD1, and the second display area DA2 of the first display unit 1811. If the display device 100 is in an unfolded state, the first hinge portion 1831 may be in an unfolded state.

If the display device 100 is in an unfolded state, the first display area DA1, the first bending area BD1, and the second display area DA2 may have continuous surfaces. For example, the first display area DA1 may include a first surface on which an image is displayed and a second surface located opposite the first surface, and the second display area DA2 may include a third surface on which an image is displayed and a fourth surface located opposite the third surface. The portion from the first surface to the third surface may be continuous surfaces. Additionally, the portion from the second surface to the fourth surface may be continuous surfaces.

When the display device 100 is in a folded state, the image may be displayed only through the third display area DA3 of the second display unit 1824. When the display device 100 is in a folded state, the first hinge portion 1831 may be in a folded state. The third display area DA3 may include a fifth surface and a sixth surface on which an image is displayed, and the third display area DA3 may overlap with the second display area DA2.

Referring to FIG. 17, after the first hinge portion 1831 is bent, the light emitting devices ED disposed in the first display area DA1 and the second display area DA2 do not emit light, and an image may be displayed through the light emitting devices ED disposed in the third display area DA3.

Referring to FIG. 17, after the first hinge portion 1831 is bent, the third display area DA3 may overlap with the first display area DA1 and the second display area DA2.

Referring to FIG. 17, after the first hinge portion 1831 is bent, time information may be displayed in the third display area DA3. That is, the display device 100 may perform a function similar to a clock.

Referring to FIG. 17, after the first hinge portion 1831 is bent, the driver DRV may detect a touch operation occurring in the third display area DA3 during a touch sensing period.

Referring to FIG. 17, after the first hinge portion 1831 is bent, during the touch sensing period, the driver DRV may supply a touch driving signal to a row line RL located in the third display area DA3 among a plurality of row lines RL.

That is, the display device 100 may be folded or unfolded. When the display device 100 is unfolded, an image is displayed through the display areas DA1, DA2 and DA3, and the bending areas BD1 and BD2, and a touch operation may also be possible. When the display device 100 is folded, an image is displayed through the third display area DA3, and a touch operation may be possible.

Meanwhile, the third display area DA3 may overlap with the second display area DA2. That is, the portions corresponding to the second display area DA2 and the third display area DA3 of the display device 100 may be in the form of a double-sided display device 100. Hereinafter, it will be described a cross-sectional view of the display device 100 for the second display area DA2 and the third display area DA3.

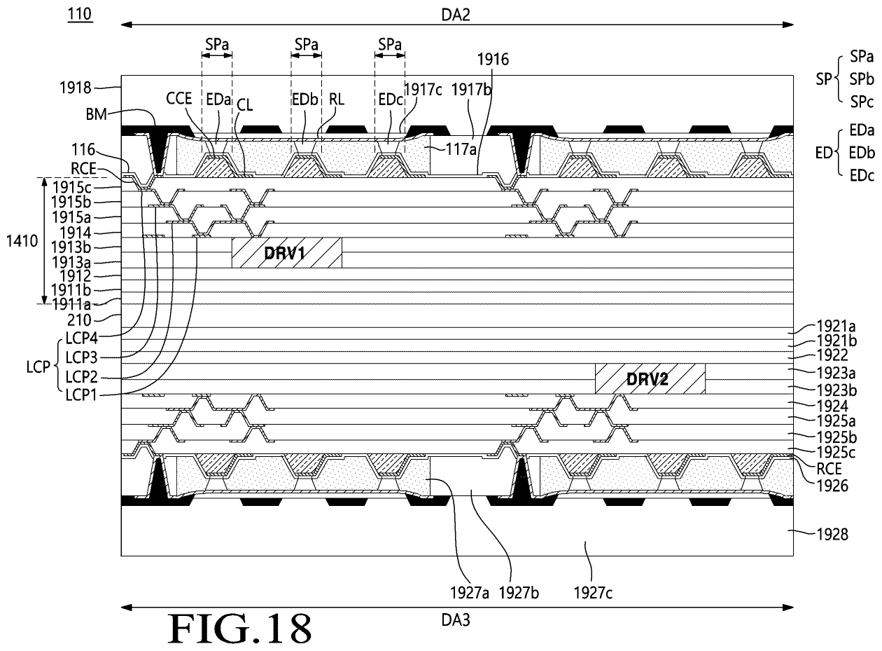

FIG. 18 is a cross-sectional view of a display device 100 for a second display area DA2 and a third display area DA3 according to embodiments of the present disclosure.

Buffer layers 1911a and 1911b may be disposed on a substrate 210. The characteristics of the buffer layers 1911a and 1911b illustrated in FIG. 18 may be the same as the buffer layers 1511a and 1511b illustrated in FIG. 10. The driver may be disposed on the buffer layers 1911a and 1911b. The characteristics of the driver DRV1 illustrated in FIG. 18 may be the same as the driver DRV illustrated in FIG. 10. An adhesive layer 1912 and the protection layers 1913a and 1913b may be disposed on the buffer layers 1911a and 1911b. The characteristics of the adhesive layer 1912 and the protection layers 1913a and 1913b illustrated in FIG. 18 may be the same as those of the adhesive layer 1512 and the protection layers 1513a and 1513b illustrated in FIG. 10.

On the protection layers 1913a and 1913b, there may be sequentially arranged an upper protection layer 1914, a plurality of insulating layers 1915a, 1915b and 1915c, a plurality of line connection patterns LCP, a row connection electrode RCE, a plurality of banks BNK, a plurality of column lines CL, a passivation layer 1916, a plurality of row lines RL, a plurality of optical layers 1917a, 1917b and 1917c, and a cover layer 1918. The features of the upper protection layer 1914, the plurality of insulating layers 1915a, 1915b and 1915c, the plurality of line connection patterns LCP, the row connection electrodes RCE, the plurality of banks BNK, the plurality of column lines CL, the passivation layer 1916, the plurality of row lines RL, the plurality of optical layers 1917a, 1917b and 1917c, and the cover layer 1918 illustrated in FIG. 18 may be the same as the features of the upper protection layer 1514, the plurality of insulating layers 1515a, 1515b and 1515c, the plurality of line connection patterns LCP, the row connection electrodes RCE, the plurality of banks BNK, the plurality of column lines CL, the passivation layer 1516, the plurality of row lines RL, the plurality of optical layers 1517a, 1517b and 1517c, and the cover layer 1518 illustrated in FIG. 10.

Referring to FIG. 18, some of the plurality of light emitting devices EDa, EDb and EDc may overlap with the first driver DRV1. However, referring to FIG. 18, some of the plurality of light emitting devices EDa, EDb and EDc may not overlap with the first driver DRV1. For example, the light emitting device EDb located at the upper left may overlap with the first driver DRV1, and the light emitting devices ED located at the upper right may not overlap with the first driver DRV1.

Referring to FIG. 18, the components disposed at the upper part of the substrate 210 may be disposed at the lower part of the substrate 210 in the same manner. The characteristics of the components arranged at the upper part of the substrate 210 may be the same as the characteristics of the components arranged at the lower part of the substrate 210.

Referring to FIG. 18, the buffer layers 1921a and 1921b may be disposed under the substrate 210.

Referring to FIG. 18, the second driver DRV2 may be disposed under the buffer layers 1921a and 1921b.

Referring to FIG. 18, the protection layers 1923a and 1923b may be disposed under the buffer layers 1921a and 1921b.

Referring to FIG. 18, an upper protection layer 1924, a plurality of insulating layers 1925a, 1925b and 1925c, a plurality of line connection patterns LCP, a row connection electrode RCE, a plurality of banks BNK, a plurality of column lines CL, a passivation layer 1926, a plurality of row lines RL, a plurality of optical layers 1927a, 1927b and 1927c, and a cover layer 1928 may be sequentially arranged on the protection layers 1923a and 1923b.

Referring to FIG. 18, some of the plurality of light emitting devices EDa, EDb and EDc may overlap with the second driver DRV2. However, referring to FIG. 18, some of the plurality of light emitting devices EDa, EDb and EDc may not overlap with the second driver DRV2.

Referring to FIG. 18, the first driver DRV1 may not overlap with the second driver DRV2. However, depending on the design, the first driver DRV1 may overlap with the second driver DRV2.

A touch operation may be detected through the first driver DRV1 at the location where the first driver DRV1 is disposed. A touch operation may be detected through the second driver DRV2 at the location where the second driver DRV2 is disposed. Hereinafter, the touch operation of the display device 100 will be described.

FIG. 19 illustrates the touch operation of the display device 100 according to embodiments of the present disclosure.

The display device 100 may include a first touch area TA1, a second touch area TA2, and a third touch area TA3.

The first touch area TA1 may overlap with the first display area DA1. The first touch area TA1 may overlap with a part of the first bending area BD1. A plurality of touch electrodes TE may be disposed in the first touch area TA1. The plurality of touch electrodes TE may be arranged in a matrix form of 7*6, and the number of the plurality of touch electrodes TE may be 42. However, the shape and number of the plurality of touch electrodes TE are not limited thereto.

The second touch area TA2 may overlap with the second display area DA2. The second touch area TA2 may overlap with a portion of the first bending area BD1. A plurality of touch electrodes TE may be arranged in the second touch area TA2. The plurality of touch electrodes TE may be arranged in a matrix form of 7*6, and the number of the plurality of touch electrodes TE may be 42. However, the shape and number of the plurality of touch electrodes TE are not limited thereto.

The third touch area TA3 may overlap with the third display area DA3. A plurality of touch electrodes TE may be arranged in the third touch area TA3. The plurality of touch electrodes TE may be arranged in a matrix form of 7*6, and the number of the plurality of touch electrodes TE may be 42. However, the shape and number of the plurality of touch electrodes TE are not limited thereto.

The period during which the touch operation is driven may include a normal touch driving period T_N and a hover touch driving period T_H.

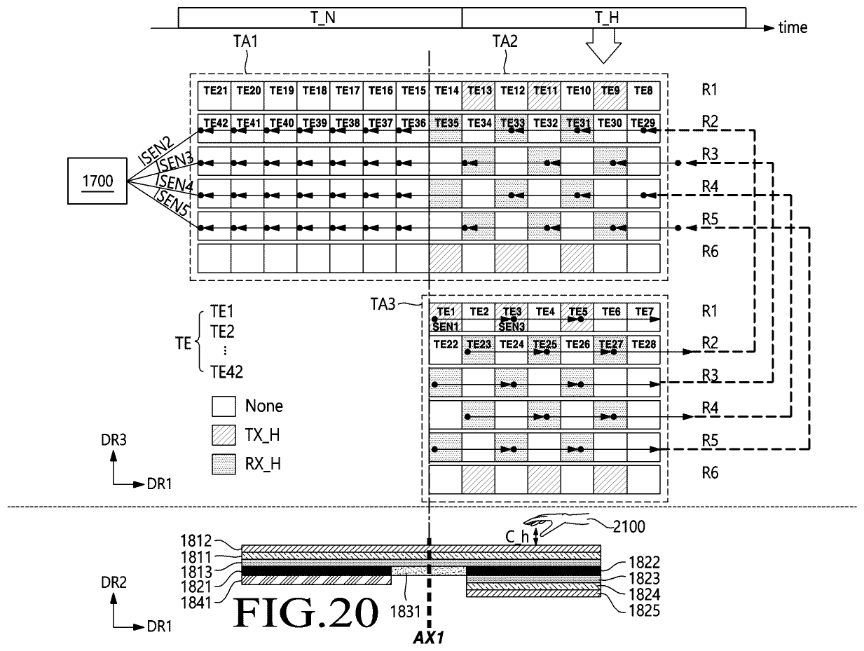

The normal touch driving period T_N may be a period in which a touch by an object such as a finger, a pen, a stylus is detected. The hover touch driving period T_H may be a period in which the motion of an object that is away from the display device 100 is detected. After describing the normal touch driving period T_N with reference to FIG. 19, the hover touch driving period T_H will be described with reference to FIG. 20.

A plurality of drivers DRV may be disposed in an area where each of the plurality of touch electrodes TE is located. In this case, touch driving may be performed for each of the plurality of touch electrodes TE. If the drivers DRV are arranged in all areas, the driving method may be easy, but there may be insufficient the space where the drivers DRV are disposed. Therefore, the drivers DRV may not be disposed in some of the touch areas TA1, TA2 and TA3. That is, in an area where one of the plurality of touch electrodes TE is disposed, a driver DRV for touch driving may not be disposed at all. This will be described in more detail below.

For example, touch driving may not be performed for some of the plurality of touch electrodes TE. Touch driving may be performed for each of the plurality of touch electrodes TE located in the first touch area TA1. The driver arranged in the second touch area TA2 may not overlap with a driver DRV arranged in the third touch area TA3, and the cross-sectional view thereof may be the same as the first driver DRV1 and the second driver DRV2 illustrated in FIG. 18.

For example, touch driving may be performed for only 21 among the 42 touch electrodes TE in the second touch area TA2. The 21 touch electrodes TE may be arranged in a mosaic shape, and the 21 touch electrodes TE may be arranged in a diagonal shape from the upper right to the lower left and a diagonal shape from the upper left to the lower right. That is, the 21 touch electrodes TE may be arranged in a plurality of diamond shapes or a plurality of X shapes.

Touch driving may be performed only for 21 touch electrodes TE among the 42 touch electrode TE in third touch areas TA3. The positions of the 21 touch electrodes TE of the third touch area TA3 may be opposite to the positions of the 21 touch electrodes TE touch-driven in the second touch area TA2. That is, the positions of the 21 touch electrodes TE of the third touch area TA3 may be the same as the positions of the 21 touch electrodes TE that are not touch-driven in the second touch area TA2.

A 14-th touch electrode TE14 of the second touch area TA2 may overlap with a first touch electrode TE1 of the third touch area TA3. The first touch electrode TE1 may receive a touch driving signal.

A 13-th touch electrode TE13 of the second touch area TA2 may overlap with a second touch electrode TE2 of the third touch area TA3. The 13-th touch electrode TE13 may receive a touch driving signal.

A 12-th touch electrode TE12 of the second touch area TA2 may overlap with a third touch electrode TE3 of the third touch area TA3. The third touch electrode TE3 may receive a touch driving signal.

An 11-th touch electrode TE11 of the second touch area TA2 may overlap with a fourth touch electrode TE4 of the third touch area TA3. The 11-th touch electrode TE11 may receive a touch driving signal.

A tenth touch electrode TE10 of the second touch area TA2 may overlap with a fifth touch electrode TE5 of the third touch area TA3. The fifth touch electrode TE5 may receive a touch driving signal.

A ninth touch electrode TE9 of the second touch area TA2 may overlap with a sixth touch electrode TE6 of the third touch area TA3. The ninth touch electrode TE9 may receive a touch driving signal.

An eighth touch electrode TE8 of the second touch area TA2 may overlap with a seventh touch electrode TE7 of the third touch area TA3. The seventh touch electrode TE7 may receive a touch driving signal.

A 22-nd touch electrode TE22 of the second touch area TA2 may overlap with a 35-th touch electrode TE35 of the third touch area TA3. The 35-th touch electrode TE35 may receive a touch driving signal.

A 23-rd touch electrode TE23 of the second touch area TA2 may overlap with the 34-th touch electrode TE34 of the third touch area TA3. The 23rd touch electrode TE23 may receive a touch driving signal.

A 24-th touch electrode TE24 of the second touch area TA2 may overlap with a 33rd touch electrode TE33 of the third touch area TA3. The 33rd touch electrode TE33 may receive a touch driving signal.

A 25-th touch electrode TE25 of the second touch area TA2 may overlap with a 32-nd touch electrode TE32 of the third touch area TA3. The 25-th touch electrode TE25 may receive a touch driving signal.

A 26-th touch electrode TE26 of the second touch area TA2 may overlap with a 31-st touch electrode TE31 of the third touch area TA3. The 31st touch electrode TE31 may receive a touch driving signal.

A 27-th touch electrode TE27 of the second touch area TA2 may overlap with ae 30-th touch electrode TE30 of the third touch area TA3. The 27-th touch electrode TE27 may receive a touch driving signal.

A 28-th touch electrode TE28 of the second touch area TA2 may overlap with a 29-th touch electrode TE29 of the third touch area TA3. The 29-th touch electrode TE29 may receive a touch driving signal.

The description above will be omitted below to avoid repetitive explanation, and the touch driving signal may be supplied to only some of the touch electrodes TE. Referring to FIG. 19, the touch electrodes TE through which touch sensing is performed while the touch driving signal is supplied may be arranged in a mosaic form.

The sensing data SEN for touch electrodes TE may be created as integrated sensing data ISEN by a cascading method. The cascading method may mean a method in which data is gradually accumulated while being shifted. Hereinafter, it will be described the process of creating integrated sensing data ISEN.

The first sensing data SEN1 for the first touch electrode TE1 may be integrated with the third sensing data SEN3 for the third touch electrode TE3. In addition, the sensing data SEN for each of the fifth touch electrode TE5, the seventh touch electrode TE7, the ninth touch electrode TE9, the 11-th touch electrode TE11, the 13-th touch electrode TE1), the 15-th touch electrode TE15 to the 21-st touch electrode TE21 may be integrated to create integrated sensing data ISEN. The integrated sensing data ISEN may be supplied to the touch control circuit 1700. The touch control circuit 1700 may determine the occurrence of a touch and the touch coordinates based on the integrated sensing data ISEN. The above-described features may correspond to the features of the integrated sensing data ISEN for the first row R1. The features of the integrated sensing data ISEN for the first row R1 may be the same as the integrated sensing data ISEN for each of the second row R2 to the sixth row R6.

Referring to FIG. 19, the sensing data SEN for each of the 23-rd touch electrode TE23, the 25-th touch electrode TE25, the 27-th touch electrode TE27, the 29-th touch electrode TE29, the 31-st touch electrode TE31, the 33-rd touch electrode TE33, the 35-th touch electrode TE35, the 36-th touch electrode TE36 to the 42-nd touch electrode TE42 may be sequentially integrated to generate integrated sensing data ISEN for the second row R2. The same may apply to the case where integrated sensing data ISEN for each of the third row R3 to the sixth row R6 are created. Next, the hover touch driving period T_H will be described.

FIG. 20 illustrates the hover touch operation of the display device 100 according to embodiments of the present disclosure.

The normal touch driving period T_N may be performed in a different period from the hover touch driving period T_H.

The normal touch driving period T_N may be a period during which a self-capacitance-based touch driving method or a mutual-capacitance-based touch driving method is performed.

The hover touch driving period T_H may be a period for detecting the operation of the object 2100 by supplying a touch driving signal only to specific touch electrodes TE and integrating the sensing data SEN for the remaining touch electrodes TE.

The hover touch driving period T_H may be implemented through touch electrodes TE located in the second touch area TA2 and the third touch area TA3.

Referring to FIG. 20, the plurality of touch electrodes TE may include a first type touch electrode TX_H, a second type touch electrode RX_H, and a third type touch electrode NONE. The first type touch electrode TX_H may be a touch electrode TE that receives a hover touch driving signal. The second type touch electrode RX_H may be a touch electrode TE that performs sensing for a hover touch. The third type touch electrode NONE may be a touch electrode TE that is not supplied with a hover touch driving signal and in which touch sensing does not perform.

A hover touch driving signal may be supplied to a plurality of touch electrodes TE located in a first row R1 of a second display area DA2. A hover touch driving signal may be supplied to a plurality of touch electrodes TE located in a sixth row R6 of a second display area DA2. A hover touch driving signal may be supplied to a plurality of touch electrodes TE positioned in a first row R1 of a third display area DA3. A hover touch driving signal may be supplied to a plurality of touch electrodes TE positioned in a sixth row R6 of a third display area DA3.

For example, the first touch electrode TE1, the third touch electrode TE3, the fifth touch electrode TE5, the seventh touch electrode TE7, the ninth touch electrode TE9, the 11-th touch electrode TE11, and the 13-th touch electrode TE13 may receive a hover touch driving signal.

After the hover touch driving signal is supplied, touch sensing may be performed on some of the plurality of touch electrodes TE arranged in the second display area DA2 and the third display area DA3.

Referring to FIG. 20, in the second display area DA2, touch sensing may be performed on some of the plurality of touch electrodes TE arranged in the second row R2 to the fifth row. In the third display area DA3, touch sensing may be performed on some of the plurality of touch electrodes TE arranged in the second row R2 to the fifth row R5.

For example, touch sensing may be performed for the 23-rd touch electrode TE23, the 25-th touch electrode TE25, the 27-th touch electrode TE27, the 29-th touch electrode TE29, the 31-st touch electrode TE31, the 33-rd touch electrode TE33, and the 35-th touch electrode TE35. In this case, integrated sensing data ISEN may be generated by the cascading method.

Integrated sensing data ISEN for the second row R2 may include sensing data SEN for each of the 23-rd touch electrode TE23, the 25-th touch electrode TE25, the 27-th touch electrode TE27, the 29-th touch electrode TE29, the 31-st touch electrode TE31, the 33-rd touch electrode TE33, and the 35-th touch electrode TE35. The characteristics of the integrated sensing data ISEN for the second row R2 may be the same as the characteristics of the integrated sensing data ISEN for each of the third row R3 to the fifth row R5.

The touch control circuit 1700 may receive the integrated sensing data ISEN. The touch control circuit 1700 may synthesize the integrated sensing data ISEN by a channel binding technique. The integrated sensing data ISEN synthesized by the channel binding technique may be used to detect a change in capacitance. The presence or absence of the operation of an object 2100 separated from the display device 100 may be determined through the change in capacitance.

However, even if the channel binding technique is not applied, the operation of the object 2100 may be determined. For example, the touch control circuit 1700 may interpret the second integrated sensing data ISEN2 to the fifth integrated sensing data ISEN5 to determine the sensing data SEN included in the integrated sensing data ISEN2, ISEN3, ISEN4 and ISEN5, respectively. Each of the integrated sensing data ISEN2, ISEN3, ISEN4 and ISEN5 may include information on capacitance or capacitance change amount for the touch electrode TE. The touch control circuit 1700 may determine the operation of the object 2100 based on the information after checking all the sensing data SEN for the position.

A display device according to embodiments of the present disclosure may be described as follows.

Embodiments of the present disclosure may provide a display device including a substrate, a plurality of display areas, an area between the plurality of display areas that is bendable, a plurality of drivers disposed on the substrate and positioned in the plurality of display areas, a plurality of light emitting devices positioned on the plurality of drivers and overlapping with the plurality of drivers, a plurality of column lines electrically connected to a first electrode of each of the plurality of light emitting devices, and a plurality of row lines electrically connected to a second electrode of each of the plurality of light emitting devices. The display device may include a first display area including a first surface on which an image is displayed and a second surface opposite the first surface, a second display area spaced apart from the first display area, and including a third surface on which an image is displayed and a fourth surface opposite the third surface, a third display area overlapping with the second display area, and including a fifth surface and a sixth surface on which an image is displayed, and a first bending area between the first display area and the second display area. The first surface and the third surface may be continuous surfaces, and the second surface and the fourth surface may be continuous surfaces, and the third display area may overlap with the second display area.

The display device according to embodiments of the present disclosure may further include a first adhesive layer disposed under the substrate, a first bottom plate disposed under the first adhesive layer and overlapping with the first display area, a second bottom plate disposed under the first adhesive layer and overlapping with the second display area, a first hinge portion connecting the first bottom plate and the second bottom plate, and overlapping with the first bending area, a first frame disposed under the first bottom plate, and a second adhesive layer disposed under the second bottom plate and overlapping with the third display area.

The first hinge portion may bent in a first rotational direction. After the first hinge portion is bent, a first distance from the second display area to the first display area may be smaller than a second distance from the second display area to the third display area.

The display device according to embodiments of the present disclosure may further include a first display unit disposed on the first adhesive layer and including a plurality of light emitting devices, and a second display unit disposed under the second adhesive layer and including a plurality of light emitting devices. After the first hinge portion is bent, the first display unit may be folded based on a first axis, and the second display unit may be in a flat state.

After the first hinge portion is bent, a light emitting device arranged in the first display area and the second display area may not emit light, and an image may be displayed through a light emitting device arranged in the third display area.

After the first hinge portion is bent, the third display area may overlap with the first display area and the second display area.

After the first hinge portion is bent, the third display area may display time information.

After the first hinge portion is bent, the first driver included in the plurality of drivers may detect a touch operation occurring in the third display area during a touch sensing period.

After the first hinge portion is bent, the first driver may supply a touch driving signal to a row line located in the third display area among the plurality of row lines during the touch sensing period.

The display device according to embodiments of the present disclosure may further include a plurality of touch electrodes disposed on the substrate. Each of the plurality of touch electrodes may couple with a portion of the plurality of row lines.

A part of the plurality of light emitting devices may be located in the first bending area, and the first bending area may be an area capable of displaying an image and detecting a touch operation.

No image is displayed in the third display area when an image is displayed through the first display area and the second display area, and no image is displayed through the first display area and the second display area when an image is displayed in the third display area.

The display device according to embodiments of the present disclosure may further include a first touch electrode disposed in the first display area, a second touch electrode disposed in the second display area, and a third touch electrode disposed in the third display area.

The second touch electrode may overlap with the third touch electrode, and the second touch electrode may receive a touch driving signal, and the third touch electrode may not receive a touch driving signal.

The display device according to embodiments of the present disclosure may further include a fourth touch electrode that does not overlap with the second touch electrode. When the second touch electrode receives a touch driving signal, the first touch electrode may receive the touch driving signal.

The first sensing data for the second touch electrode may be integrated with second sensing data for the fourth touch electrode to create integrated sensing data. The display device may further include a touch circuit configured to receive the integrated sensing data.

The display device according to embodiments of the present disclosure may further include a plurality of touch electrodes. The plurality of touch electrodes may include a first type touch electrode that receives a hover touch driving signal, a second type touch electrode that determines an occurrence of a touch, and a third type touch electrode that does not receive the hover touch driving signal and does not determine an occurrence of a touch.

The first type touch electrode may be located in a first row of the second display area, the last row of the second display area, a first row of the third display area, and the last row of the third display area. The second type touch electrode may be located between the first row and the last row of the second display area, and between the first row and the last row of the third display area.

A period during which the plurality of touch electrodes are driven may include a first period during which a touch driving signal is supplied and a second period during which the hover touch driving signal is supplied. An occurrence of a touch of an object contacting the display device may be determined during the first period, and an occurrence of an operation of an object adjacent to the display device may be determined during the second period.

Embodiments of the present disclosure may provide a display device including a substrate, a plurality of display areas, an area between the plurality of display areas that is bendable, a plurality of light emitting devices positioned on a plurality of drivers disposed on the substrate, a plurality of column lines electrically connected to a first electrode of each of the plurality of light emitting devices, and a plurality of row lines electrically connected to a second electrode of each of the plurality of light emitting devices. A touch driving signal may be supplied to at least some of the plurality of row lines during a touch sensing period. The display device may include a first display area including a first surface on which an image is displayed and a second surface opposite the first surface, a second display area spaced apart from the first display area, and including a third surface on which an image is displayed and a fourth surface opposite the third surface, a third display area overlapping with the second display area, and including a fifth surface and a sixth surface on which an image is displayed, and a first bending area between the first display area and the second display area. The first surface and the third surface may be continuous surfaces, and the second surface and the fourth surface may be continuous surfaces. The third display area may overlap with the second display area.

The above description has been presented to enable any person skilled in the art to make and use the technical idea of the present invention, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present invention. The above description and the accompanying drawings provide an example of the technical idea of the present invention for illustrative purposes only. That is, the disclosed embodiments are intended to illustrate the scope of the technical idea of the present invention. The scope of protection of the present disclosure should be construed based on the following claims, and all technical features within the scope of equivalents thereof should be construed as being included within the scope of the present disclosure.

What is claimed is:

1. A display device, comprising:
a substrate;
a plurality of display areas;
an area between the plurality of display areas, wherein the area is bendable;
a plurality of drivers disposed on the substrate and positioned in the plurality of display areas;
a plurality of light emitting devices positioned on the plurality of drivers and overlapping with the plurality of drivers;
a plurality of column lines electrically connected to a first electrode of each of the plurality of light emitting devices; and
a plurality of row lines electrically connected to a second electrode of each of the plurality of light emitting devices,
wherein the display device includes:
a first display area including a first surface and a second surface opposite the first surface, wherein the display device is configured to display an image on the first surface;
a second display area spaced apart from the first display area, and including a third surface and a fourth surface opposite the third surface, wherein the display device is configured to display an image on the third surface;
a third display area overlapping with the second display area, and including a fifth surface and a sixth surface, wherein the display device is configured to display an image on the sixth surface; and
a first bending area between the first display area and the second display area,
wherein the first surface and the third surface are continuous surfaces, and the second surface and the fourth surface are continuous surfaces, and
wherein the third display area overlaps with the second display area.

2. The display device of claim 1, further comprising:
a first adhesive layer disposed under the substrate;
a first bottom plate disposed under the first adhesive layer and overlapping with the first display area;
a second bottom plate disposed under the first adhesive layer and overlapping with the second display area;
a first hinge portion connecting the first bottom plate and the second bottom plate, and overlapping with the first bending area;
a first frame disposed under the first bottom plate; and
a second adhesive layer disposed under the second bottom plate and overlapping with the third display area.

3. The display device of claim 2, wherein the first hinge portion is bent in a first rotational direction,
wherein, after the first hinge portion is bent, a first distance from the second display area to the first display area is smaller than a second distance from the second display area to the third display area.

4. The display device of claim 3, further comprising:
a first display unit disposed on the first adhesive layer and including a plurality of light emitting devices; and
a second display unit disposed under the second adhesive layer and including a plurality of light emitting devices,
wherein, after the first hinge portion is bent, the first display unit is folded based on a first axis, and the second display unit is in a flat state.

5. The display device of claim 3, wherein, after the first hinge portion is bent, a light emitting device disposed in the first display area and the second display area do not emit light, and an image is displayed through a light emitting device disposed in the third display area.

6. The display device of claim 3, wherein, after the first hinge portion is bent, the third display area overlaps with the first display area and the second display area.

7. The display device of claim 3, wherein, after the first hinge portion is bent, the third display area displays time information.

8. The display device of claim 3, wherein, after the first hinge portion is bent, a first driver included in the plurality of drivers detects a touch operation occurring in the third display area during a touch sensing period.

9. The display device of claim 8, wherein, after the first hinge portion is bent, the first driver supplies a touch driving signal to a row line located in the third display area among the plurality of row lines during the touch sensing period.

10. The display device of claim 1, further comprising a plurality of touch electrodes disposed on the substrate,
wherein each of the plurality of touch electrodes couples with a portion of the plurality of row lines.

11. The display device of claim 1, wherein a part of the plurality of light emitting devices are located in the first bending area,
wherein the first bending area is an area configured to display an image and detect a touch operation.

12. The display device of claim 1, wherein no image is displayed in the third display area when an image is displayed through the first display area and the second display area,
wherein no image is displayed through the first display area and the second display area when an image is displayed in the third display area.

13. The display device of claim 1, further comprising:
a first touch electrode disposed in the first display area;
a second touch electrode disposed in the second display area; and
a third touch electrode disposed in the third display area.

14. The display device of claim 13, wherein the second touch electrode overlaps with the third touch electrode,
wherein the second touch electrode is configured to receive a touch driving signal, and the third touch electrode is configured to not receive a touch driving signal.

15. The display device of claim 13, further comprising a fourth touch electrode that does not overlap with the second touch electrode,
wherein, when the second touch electrode receives a touch driving signal, the first touch electrode receives the touch driving signal.

16. The display device of claim 15, wherein first sensing data for the second touch electrode is integrated with second sensing data for the fourth touch electrode to create integrated sensing data,
wherein the display device further includes a touch circuit configured to receive the integrated sensing data.

17. The display device of claim 1, further comprising a plurality of touch electrodes,
wherein the plurality of touch electrodes include:
a first type touch electrode configured to receive a hover touch driving signal;
a second type touch electrode configured to determine an occurrence of a touch; and
a third type touch electrode configured to not receive the hover touch driving signal and configured to not determine an occurrence of a touch.

18. The display device of claim 17, wherein the first type touch electrode is located in a first row of the second display area, a last row of the second display area, a first row of the third display area, and a last row of the third display area,
wherein the second type touch electrode is located between the first row and the last row of the second display area, and between the first row and the last row of the third display area.

19. The display device of claim 17, wherein a period during which the plurality of touch electrodes are driven includes a first period during which a touch driving signal is supplied and a second period during which the hover touch driving signal is supplied,
wherein an occurrence of a touch of an object contacting the display device is determined during the first period, and
wherein an occurrence of an operation of an object adjacent to the display device is determined during the second period.

20. A display device, comprising:
a substrate;
a plurality of display areas;
an area between the plurality of display areas, wherein the area is bendable;
a plurality of light emitting devices positioned on a plurality of drivers disposed on the substrate;
a plurality of column lines electrically connected to a first electrode of each of the plurality of light emitting devices; and
a plurality of row lines electrically connected to a second electrode of each of the plurality of light emitting devices,
wherein at least some of the plurality of row lines are configured to receive a touch driving signal during a touch sensing period,
wherein the display device includes:
a first display area including a first surface and a second surface opposite the first surface, wherein the display device is configured to display an image on the first surface;
a second display area spaced apart from the first display area, and including a third surface and a fourth surface opposite the third surface, wherein the display device is configured to display an image on the third surface;
a third display area overlapping with the second display area, and including a fifth surface and a sixth surface, wherein the display device is configured to display an image on the sixth surface; and
a first bending area between the first display area and the second display area,
wherein the first surface and the third surface are continuous surfaces, and the second surface and the fourth surface are continuous surfaces, and
wherein the third display area overlaps with the second display area.
